(19) United States
(12) Patent Application Publication
(10) Pub. No.: US 2017/0146034 A1
(43) Pub. Date: May 25, 2017

(54) A FLUID ACTUATOR ARRANGEMENT

(71) Applicant: SAAB AB, Linköping (SE)

(72) Inventor: Magnus Landberg, Linköping (SE)

(21) Appl. No.: 15/319,042

(22) PCT Filed: Jun. 12, 2015
(86) PCT No.: PCT/SE2015/050684

§ 371 Date: Dec. 15, 2016

(30) Foreign Application Priority Data
Jun. 18, 2014 (SE) PCT/SE2014/050753

(51) Int. Cl. F15B 11/036; F15B 15/26; B64C 13/40; F15B 15/14

(52) U.S. Cl. CPC F15B 11/0365; F15B 15/1447; F15B 15/262; B64C 13/40; F15B 2211/7056; F15B 2211/72; F15B 2211/455

(57) ABSTRACT

The present invention regards a fluid actuator arrangement comprising a first and second cylinder of a cylinder arrangement, a piston rod arrangement, a first and second piston device associated with the piston rod arrangement, wherein respective first and second piston device divides respective first and second cylinder into a first and second chamber provided for connection to a valve device of a fluid supply device. The first piston device comprises a piston rod engagement and disengagement device, which is adapted to engage or disengage the first piston device to/from the piston rod arrangement. The invention can be put into use for aircraft, such as commercial aircraft designed for long distance flights, for construction industry, jacking systems for oil well drilling and service platforms, agricultural equipment industry, marine industry, crane manufacture industry, and others.

### TECHNICAL FIELD

The present invention relates to a fluid actuator arrangement according to the preamble of claim 1 and to a method for controlling a fluid actuator arrangement according to claim 16. The invention also regards a data medium storing program comprising a program code, which program when run on a computer executes the method according to claim 16. The invention also regards an apparatus arranged to be infinitely movable according to claim 18.

The present invention concerns the industry using hydraulic and pneumatic actuators for different types of applications and concerns the manufacture industry producing such arrangements.

The invention is not limited thereto, but can also be used for replacing electrical actuator arrangements and can be adapted for application of a wide range of different types industries.

### BACKGROUND ART

There is a desire to provide a fluid actuator arrangement that can distribute control functionality regarding force and motion rate of the piston rod arrangement.

Current technology uses fluid actuator arrangements that are designed with specific features for achieving optimal pressure. This may imply overweight and over-dimension materials, which for a specific operating mode may be regarded as superfluous.

Current technology also often uses a centrally controlled operation of maximum motion rate (speed) and force of the piston rod arrangement by means of controlling the fluid flow and pressure of the fluid supply device. Such centrally controlled feeding of fluid makes the current arrangement ineffective.

There is a desire to eliminate inefficient throttling processes performed by servo valves controlling prior art fluid actuator arrangements. Such throttling involves wasted energy through heat dissipation and high energy costs.

U.S. Pat. No. 4,506,867 discloses a jacking apparatus for effecting motion of loads by means of two double-acting hydraulic cylinders for providing increased force of a power stroke. Hydraulic fluid pressure is controlled to a predetermined flow rate to the hydraulic cylinders for increasing the speed of a repositioning stroke of the apparatus.

U.S. Pat. No. 3,220,317 discloses a servo system having a hydraulic motor system with two pistons arranged in tandem for each motor. The system uses two motors connected in parallel so that their motions are in fixed proportions and their forces are added. The system may also be arranged with the motors in series so that forces are in fixed proportions and motion added.

There is an object to reach more efficient control of speed and force of a fluid actuator arrangement.

Yet another object is to reduce power output of the fluid supply device (pump).

There is also an object to reduce energy losses.

A further object is to develop an energy saving fluid actuator arrangement comprising compact cylinders promoting the benefits of longer piston rod arrangements having longer piston rod path compared with prior art fluid actuator arrangements.

A yet further object is thus to provide a more compact fluid actuator arrangement.

An object is to provide a fluid actuator arrangement exhibiting a lower weight compared with prior art fluid actuator arrangements.

An object is to improve current fluid actuator arrangements in mobile and industrial applications.

An object is to provide fluid actuator arrangements to accomplish work with only a small amount of input force.

A further object is to increase energy efficiency for a fluid actuator arrangement operating under various motion/movement and force performance selected from actual requirement or condition, without need of additional energy consuming throttling valves.

Furthermore, an object is to reduce the size of components and systems of a fluid actuator arrangement, while maintaining or increasing power output.

A further object is to provide a fluid actuator arrangement, which can be used in smart fluid power component systems including self-diagnostics and plug-and-play (easy to use) functionality.

A yet further object is to minimize the environmental impact by lowering noise and eliminating large leaks.

An object is to provide a fluid actuator arrangement that can be used cost-effective in material handling equipment applications. Material handling equipment, such as electronic overhead travelling cranes, level luffing cranes and stackers can thus make use of the present fluid actuator arrangement. Also other types of cranes may make use of the arrangement, such as overhead cranes, mobile cranes, tower cranes, telescopic cranes, loader cranes, which cranes comprise long hydraulic cylinders. Also forklifts, telehandlers and production line conveyors may make use of the present fluid actuator arrangement. The application of the present fluid actuator arrangement covers a major range of industries, such as oil refineries, power and energy facilities, food and beverage industries, retails, container terminals aiming at faster solutions for container logistics offering shorter time for container ships in harbour. Also elevators for buildings may make use of the present fluid actuator arrangement. Also offshore/marine applications, paper and steel industry machinery, pneumatic industry may make use of the present fluid actuator arrangement.

A further object is to provide a fluid actuator arrangement that can be used for the production of agricultural equipment, including tractors, combine harvesters, loaders, hay balers, mulching machines and lawn and garden equipment, such as earth mowers, forest harvesters, etc.

One aspect of the present invention is to adapt the arrangement to 3D-printing in plastic, composite and/or metal applications for aircraft and automotive industry. This promotes high process speed and high accuracy for prototypes (rapid prototyping), demonstration units and small volume production.

A further object is to provide an arrangement that can be used in 3D-printing of entire buildings.

An object is to provide an arrangement that can be used in automated storage and retrieval systems for car parking and rough-terrain robots, so called legged robot systems.

A yet further object is to provide a fluid actuator arrangement that can be used in the construction end-market, including vehicles such as excavators, steam rollers, backhoe loaders, concrete machines, drilling rigs, and wheel loaders used adapted for construction of infrastructure, e.g. roads, bridges, buildings or tunnels.

Furthermore, an object is to provide a fluid actuator arrangement that can be used in the upstream oil and gas industry, primarily at the wellhead and including jacking systems used to raise and lower oil well drilling and service platforms, excavators, off-road dump trucks and rigs.

A further object is to provide a fluid actuator arrangement that can be put into use in light, medium and heavy hydraulic presses used for metal forming, including die casting, forging, extrusion, drawing, pressing machines, mould making, casting, etc.

A yet further object is to provide a fluid actuator arrangement adapted for aerospace vehicles. There is a need for weight saving and less bulky arrangements. The present fluid actuator arrangement can be used in systems for landing gears, engines, ramps, door actuation devices, brakes and wheels, flight controls and fuel systems etc. The arrangement can also be used in ground handling equipment, baggage handling equipment and specialty aircraft repair equipment. The aerospace segment has always been a major consumer of heavy duty hydraulic cylinders and arrangements for saving weight have been developed over long time. The weight saving of commercial aircraft is extremely important today regarding so called “green aviation” as less weight of the aircraft will reduce fuel consumption and thus less NOx and CO2 emissions. One aspect is thus to put the present fluid actuator arrangement in use in both civil and military applications, in manned and unmanned aircrafts, and especially for large civil aircraft.

Additionally, an object is to provide a fluid actuator arrangement that can be used in military equipment utilizing hydraulic and/or pneumatic mechanisms. This includes armoured personnel carriers, aircraft material handlers, cranes and loaders, hook lifts, track adjusters and truck-mounted bridge layers.

Large milling (CNC) machines and hydraulic robots for aircraft, automotive may make use of the fluid actuator arrangement.

An object is to provide an arrangement that can be adapted to mining machines, mine and mountain drilling rigs, etc.

A further object is to provide a fluid actuator arrangement that can be used in mining drills and breakers, crushing, pulverizing and screening equipment, mineral processing machinery, surface mining equipment, underground mining machinery and other mining equipment.

### SUMMARY OF THE INVENTION

This has been achieved by the arrangement defined in the introduction and being characterized by the features of the characterizing part of claim 1.

Thereby is achieved that the first chamber can be pressurized with a first pressure, wherein the first piston device will be secured to the piston rod arrangement by means of the piston rod engagement and disengagement device actuated by the first pressure. Disengagement of the first piston device from the piston rod arrangement is performed when the first chamber is pressurized with a second pressure or not being pressurized.

Preferably, the second pressure being lower than the first pressure.

Thereby is achieved a fluid actuator arrangement comprising at least one actuator, the definition of which corresponds to a cylinder comprising a piston device and piston rod arrangement, using a releasable piston allowing discrete adjustability of the total cross-section piston force area.

In such way it is possible to provide precise motion control without the need of current inefficient throttling process. There is therefore provided less inefficient throttling for the present arrangement than for prior art arrangements. Current motion control often involves wasted energy through heat dissipation and required heavy and expensive cooling systems.

Preferably, the valve device is adapted to control that the first pressure is higher than the second pressure and alternatively (in case of pneumatic actuator arrangement) the second pressure is reservoir pressure.

It is thus provided a modular fluid actuator arrangement that comprises three main functionalities. Firstly, a hybrid actuator comprising at least one conventional piston constantly in engagement with the piston rod may be used. Secondly, there is a possibility to use two or more cylinders in tandem using one common piston rod and wherein respective piston of each cylinder comprises a piston rod engagement and disengagement device, which is adapted to engage or disengage the piston from the piston rod. Thirdly, a locking arrangement mode is possible, wherein a piston-like clamping device using the fluid supply system or external fluid supply systems (or wherein both chambers of respective cylinder may optionally be pressurized for activating the piston engagement and disengagement device in a locked position) is used. Such application may be advantageous in case of error in operation. Said three function modes can also be combined. Such combinations may regard different force areas of the cross-sections of the pistons.

In such way is achieved that unlimited lengths of piston rods can be used that opens up for various types of industrial areas.

Thereby is achieved a possibility to control the fluid actuator arrangement in an efficient way depending upon the actual need of fluid power for a specific situation.

In such way is achieved a major reduction in power losses, when compared to prior art arrangements. Thereby, no or less throttling losses are present and it is achieved that the fluid actuator arrangements. This implies, e.g. for mobile applications, that significant fuel savings can be made and less CO2 emissions.

According to current technology, a designer must adapt prior art arrangement to match force and speed requirements e.g. to match high force and slow speed or low force and high speed by introducing servo valves. Such servo valves throttle one or several actuators depending upon desired force and rate of motion and acceleration of the piston rod.

By means of the claimed features, the designer will have a unique possibility to adjustment/management of the cylinder area of the arrangement by engaging/disengaging one or several pistons to the piston rod arrangement, thereby optimizing the performance of the actuator arrangement to varying speed and force requirements.

By means of the piston rod engagement and disengagement device, which is adapted to engage the piston device to the piston rod arrangement, there is achieved that a precise motion of the piston rod arrangement can be made in combination with a less energy consuming throttle valve.

In such way is achieved a fluid actuator arrangement that has substantially higher power to weight ratio resulting in higher machine frame resonant frequencies for a given power level and high stiffness of the control system of the present arrangement.

Thereby is provided a fluid actuator arrangement operating in a stiff manner and that achieves high loop gain capability, great accuracy and frequency response.

In such way is achieved a fluid actuator arrangement performing smooth performance at low speed and which have a wide speed range by changing the force area of the present arrangement.

This means that a fluid actuator arrangement is provided that to a great extent is self-cooling and that can be operated in stall condition indefinitely without damage.

In such way is achieved a compact, short and light-weight cylinder having a smaller volume of oil (in case of being a hydraulic actuator) in the first and second chamber of the cylinder than that of conventional hydraulic cylinders. Elongated and heavy prior art cylinders can thus be eliminated. Additional oil volume in bulky reservoir tanks is needed for prior art cylinders. Extraction and extension of prior art actuators requires large oil volume. By means of the claimed features it is provided that less bulky oil reservoir tanks can be used for the arrangement.

Preferably, the first and second cylinder are arranged in tandem and the first and second piston device being associated with a common piston rod of the piston rod arrangement.

In such way there is provided a less bulky arrangement using a common piston rod.

Current control of prior art arrangements for changing working point involves the use of energy consuming throttling valves. Such prior art throttling results in wasted energy through heat dissipation and thus requires heavy and expensive cooling systems. By means of the claimed features a cooling system of the present arrangement can be designed to be less bulky than prior art cooling systems.

Thereby are achieved reductions in weight and volume. This involves smaller components (cylinder, oil reservoir, oil cooler and fuel tank) than prior art and thus more cost-efficient assembly. In such way is achieved an arrangement having less gross weight, requiring less manufacture costs, and having a very compact design.

Suitably, the second piston device comprises a piston rod engagement and disengagement device adapted to be able to engage or disengage the second piston device to/from the piston rod arrangement.

In such way is achieved an optimal and secure functionality providing accurate performance.

Thereby is provided a compact and low-weight (and energy saving) fluid actuator arrangement that can propel a piston rod arrangement a major distance and back again, wherein the respective piston device in turn is engaged with the piston rod arrangement.

Thereby is achieved that both piston devices can be engaged with the piston rod arrangement for generating a larger force area of the piston devices. Such additional force is suitable for achieving that the piston rod arrangement can accelerate a heavy load.

Preferably, the piston device (when not in engagement with the piston rod) is centrally positioned in the cylinder for operating the fluid actuator arrangement in a symmetrically manner in opposite directions.

Optionally, this can be achieved by two spring elements provided at each side of the piston device, seen in a direction corresponding with the elongation of the piston rod arrangement.

Alternatively, this can be achieved by an electromagnetic device.

Suitably, a third cylinder comprising a third piston device is arranged in tandem with the first and second cylinder (preferably using a common piston rod).

Thereby a unique maximal long piston rod can be used for a wide range of applications, e.g. elevators, forklifts, cranes, 3D printing/CNC machines, mine drilling rigs, container terminals, profile rail guides etc. Such use of long piston rods opens up new areas for hydraulic actuators and pneumatic actuators. The length of the piston rod is not dependent on cylinder length. Also an aspect of the invention disclosing only two cylinders may involve such unique maximal long piston rod.

Alternatively, the piston rod engagement and disengagement device additionally being adapted to engage the first piston device to the piston rod arrangement, when the second chamber is pressurized.

In such way there is achieved high flexibility in speed and force. The achieved arrangement can be seen as a hydraulic “gear box”. Heavy loads can be moved at high speed with high acceleration and retardation in combination with very accurate motions at low speed.

Preferably, the piston rod engagement and disengagement device is adapted for stiff/rigid engagement (rigidity in axial direction).

This implies safe operation of the fluid actuator arrangement and optimal precision of motion.

Suitably, the piston device and the piston rod arrangement (piston rod) are free to move relative each other and also relative the cylinder per se encompassing the piston device and a portion of the piston rod.

Alternatively, the piston rod engagement and disengagement device comprises a cavity forming a flexible piston inner wall portion adapted for releasable engagement with the piston rod arrangement.

Preferably, the cavity extends around the longitudinal axis of the piston device parallel with the circumference of the bore hole of the piston device and at a proper distance from the latter so that a suitable mass of material (e.g. same material as the rest of the piston device) constitutes said piston inner wall portion. Said mass of material forming the piston inner wall portion is such flexible that increased pressure in the cavity expands the piston inner wall portion thereby clamping onto the piston rod arrangement.

By means of said flexible piston inner wall adapted for only minor movement in radial direction for clamping (secure) the piston arrangement, the number of motions is high and the arrangement can be classified as a long-life arrangement.

Thereby is achieved that a portion (comprising a section of the piston inner wall) of the material of the piston device can be used for radially clamping said portion of the piston device onto the piston rod arrangement outer surface (envelope surface) by introducing a high pressure in the cavity, thus expanding the portion (i.e. the piston inner wall of the piston device) in direction radially inwardly in engagement with the piston rod arrangement. Vice versa, the piston device is disengaged from the piston rod arrangement when the fluid not being pressurized in the cavity, wherein said portion will retract to its original state and said section of the piston inner wall moves outwardly in a radial direction from the piston rod and disengages the piston device from the envelope surface of the piston rod.

Preferably, the piston rod engagement and disengagement device comprises a membrane device adapted for releasable engagement with the piston rod arrangement.

In such way is achieved a membrane used between the piston rod and the piston device. By applying a pressurized fluid to the membrane by means of a logic valve being in fluid communication with the pressurized fluid in the actual chamber of the cylinder comprising the releasable piston device, the piston device will be connected with maximum secure, fast and reliable clamping to the piston rod arrangement. Such membrane also promotes fast disconnection (disengagement) of the piston device from the piston rod arrangement.

Preferably, the piston rod engagement and disengagement device comprises a clamping device and/or locking member

The speed and force of the piston rod can thus be controlled in an efficient way by varying the active total piston area in discrete steps. Multiple cylinder chambers with releasable pistons can be combined in several ways in order to find the most suitable speed-and-force solution for a specific application.

Suitably, the piston rod engagement and disengagement device comprises a pressure strengthening device, which is provided to strengthening the engagement of the first piston device to the piston rod arrangement.

In such way is achieved that the piston device is rigidly secured to the piston rod arrangement and which can be performed a short time period.

Preferably, the pressure strengthening device is arranged within the piston device and comprises a movable micro piston rod having a first micro pressure area and a second micro pressure area. The first micro area being larger than the second micro pressure area, and is in fluid communication with the pressurized (main) fluid. The second micro pressure area may be arranged in communication with a separate high pressure fluid provided in a cavity (for membrane functionality) of the piston device forming the cavity of the piston rod engagement and disengagement device.

Suitably, the arrangement comprises a hydraulic actuator arrangement.

Thereby is achieved that a secondary control is provided. Such secondary control is one of the most efficient control methods for hydraulic systems. Such secondary control of the present hydraulic actuator arrangement also presents low hydraulic capacitance, which additionally saves power.

In such way is achieved energy saving and reduced power demand of the primary hydraulic supply device (such as a power unit). In such way fuel consumption and operative costs being reduced. There is also achieved that cooling capacity will comply with current emission regulations.

According to one aspect of the present invention, so called secondary control of hydraulic cylinders can be realized by utilizing a multi-chamber cylinder approach with releasable (possible to disconnect/disengage) pistons. The principle of such a secondary control is to control the torque of the hydraulic motor by controlling the displacement of the motor. By means of this aspect, a variable displacement unit can be provided for a hydraulic cylinder, but also in this case the present arrangement with variable cross-sectional force area.

By means of the claimed features, the need for prior art emission reduction technology is reduced. Such prior art emission reduction technology usually is complicated, expensive and difficult to integrate into machine application and apparatuses to be used. Furthermore, by means of the claimed features is achieved that energy waste through heat dissipation is decreased and lighter, smaller and less expensive cooling systems can be used. The impact on the environment is thus less vulnerable and the present fluid actuator arrangement can be regarded as “Green” technology.

In such way is provided a high stiffness and high natural frequency (compared with prior art actuator arrangements) due to less volume used in the present cylinder chamber (compared to conventional cylinders). These factors are favourable in control design.

Preferably, a first cross-sectional force area of the first piston device differs from a second cross-sectional force area of the second piston device.

There is thus possible to control the fluid actuator arrangement performance by altering the fluid actuator arrangement's effective force area during operation. This introduces a new level of energy efficiency to hydraulic/pneumatic systems used in current power transmissions.

Suitably, the arrangement comprises a first actuator provided with a first force area, a second actuator provided with a second force area corresponding with the first force area, a third actuator provided with a third force area, a fourth actuator provided with a fourth force area, the third force area is twice as large as the first force area, the fourth force area is twice as large as the third force area.

In such way is achieved that a fast piston motion can be achieved with minor piston force. The respective force area is defined as the cross-sectional area of the respective piston device. For reaching such fast piston motion and minor force, the first force area (e.g. 1 area unit) is activated by alternating engagement of the first and second actuator to the piston rod arrangement. For achievement of an alternative performance of the arrangement, for example a slow piston motion with high force, all activators are activated. The high force may be achieved by activating all four force areas (e.g. 8 area units=1+1+2+4, i.e. the respective force area of the first, second, third, fourth actuator). This implies an optimal combination of eight different force area units, which can be selected from required piston motion rate and force of piston device. Prior art actuators can be built for 8 area units and being determined for slow piston motion with high force. However, such prior art actuator will, when used for fast motion and minor force, require that the entire cylinder volume must be pressurized and a part of the pressurized fluid (fed from the fluid supply device) must be throttled for decreasing the force. Prior art arrangements thus will generate energy losses.

Preferably, also other force area combinations are possible. For example 1+1+1+1+1+1 or 1+2+4+8+16+32 or 1+1+2+4+8+16+32 or others.

Alternatively, the arrangement comprises a plurality of actuators.

By controlling the total cross-sectional force area of the arrangement, the motion rate and the force of the piston rod can be changed and optimized in an efficient way. The actual needs of operation for a certain situation can be satisfied by changing said total cross-sectional force area of the arrangement. This is due by the formula V=Q/A and the formula F=P*A, wherein “V” is the motion rate of the piston device, “Q” is the fluid flow, “A” is the area of the piston device, “F” is the force of the piston device and “P” is the pressure of the fluid. For example, by decreasing the area “A” (e.g. by disengaging one piston), the motion rate “V” is increased at the same time as the force “F” is decreased.

In such way is achieved that a modular actuator arrangement can be assembled from desired provisions regarding force and speed of the piston rod arrangement—for example high force and slow speed or low force and high speed and furthermore desired distance for piston rod arrangement motion, braking action, precision adjustment of the piston rod arrangement to a predetermined accurate position etc. Such modular actuator arrangement can operate with less throttling compared with prior art. According to one aspect of the present invention there is provided that engagement and disengagement of piston devices to/from the piston rod arrangement will imply flexibility and less energy losses compared with prior art.

Preferably, the arrangement comprises an electro-hydraulic cylinder apparatus.

In such way is achieved accuracy, enhanced functionality, improved ease-of-use and controlled performance. Electro-hydraulic cylinders incorporate servo valves and electronic controls such as transducers to provide rod position feedback and to ensure efficient machine operations. This enables sophisticated control of speed and position of loads in several applications of the arrangement according to this aspect.

The arrangement is suitable adapted for an aircraft comprising the arrangement according to any of claims 1-13.

Suitably, the aircraft is a commercial aircraft designed for long distance flights.

The arrangement is preferably adapted for any of the following industrial segments; construction industry, jacking systems for oil well drilling and service platforms, agricultural equipment industry, marine industry, crane manufacture industry, paper and steel industry, rough-terrain robot manufacture industry or others.

Alternatively, the arrangement comprises a pneumatic actuator arrangement.

Preferably, a fluid actuator arrangement is provided that can distribute control functionality regarding force and motion rate of the piston rod arrangement providing infinite piston (and/or cylinder arrangement) transfer motion compared with prior art fluid actuator arrangements.

Suitably, first chamber is pressurized with a first pressure, wherein the first piston will be in engagement with the piston rod by means of said first pressure transferred directly to and acting upon the piston rod engagement and disengagement device via a channel system having an opening entering the first cylinder chamber and having another opening entering a cavity of a membrane.

The piston rod engagement and disengagement device is thus directly controlled by the first pressure of the pressurized first chamber, wherein said first pressure also acts onto a flexible member (membrane) of the piston rod engagement and disengagement device of the piston device, which flexible member thereby expands in radial direction towards the piston envelope surface and clamps around the piston rod.

Preferably, the piston rod engagement and disengagement device is rigidly fixed to the piston of the piston device and the first pressure of the pressurized first chamber acting onto the piston for moving the piston device in axial direction will thus also simultaneously act on the membrane of the piston rod engagement and disengagement device for actuating the piston rod engagement and disengagement device to engage it with the piston rod, thus also moving the piston rod relative the cylinder arrangement. The piston rod engagement and disengagement device will thus upon pressurizing of the first chamber be engaged with the piston rod by means of the first pressure pressing the flexible member (membrane) in radial direction towards the piston rod envelope surface.

There is thus achieved that an engagement between the piston rod and piston device is performed directly and promptly without any additional mechanical parts and can be controlled by the same control device (control valve device and control unit) which controls the movement of the piston device relative the cylinder arrangement by the pressurization of the respective cylinder chamber.

Suitably, the second piston device comprises a piston rod engagement and disengagement device adapted to be able to engage or disengage the second piston device to/from the piston rod arrangement in a similar way as described for the first piston device.

In such way is achieved an optimal and secure functionality providing accurate performance of the fluid actuator arrangement.

Thereby is provided a compact and low-weight (and energy saving) fluid actuator arrangement that can propel a piston rod arrangement a major distance and back again, wherein the respective piston device in turn is engaged with the piston rod arrangement.

In such way is achieved a membrane that can be used as a coupling device between the piston rod and the piston device.

By arranging the piston device for directly feeding the pressurized fluid from the pressurized cylinder chamber to the membrane, the piston device will be connected with maximum secure, fast and reliable clamping to the piston rod arrangement. Such directly controlled membrane also promotes fast disconnection (disengagement) of the piston device from the piston rod arrangement. Said feeding is preferably provided via a channel system of the piston device from the pressurized cylinder chamber to the membrane. By the use of a logic valve provided for controlling the flow of fluid to the respective cylinder chamber, that logic valve will thus also control the piston rod engagement and disengagement device.

The speed and force of the piston rod and/or cylinder arrangement can thus be controlled in an efficient way by varying the active total piston area in discrete steps. Multiple cylinder chambers with releasable pistons can be combined in several ways in order to find the most suitable speed-and-force solution for a specific application.

Suitably, a control unit is arranged to control the control valve (controlling the direction of motion of the piston rod) and to control a respective logic valve coupled to the respective cylinder arrangement.

The control valve is preferably arranged for directing the hydraulic flow to the cylinder chambers of the respective cylinders. It is thereby possibly to control the actuating of the piston rod engagement and disengagement device of the first piston of the first cylinder independently from controlling the piston rod engagement and disengagement device of the second piston of the second cylinder.

Suitably, the fluid supply device is provided for feeding fluid to the respective cylinder separately and/or in combination via the control valve and respective logic valve.

Preferably, each logic valve is coupled via lines/hoses (or other fluid communication devices) to the respective cylinder and to the control valve.

Each logic valve is coupled to both cylinder chambers of the respective cylinder.

Preferably, the control unit controls the valve device for pressurizing a cylinder chamber of the first cylinder, wherein is achieved instantaneously that the piston rod engagement and disengagement device of the piston device of the first cylinder is pressurized for providing engagement between the common piston rod and the piston device.

Suitably, the control unit is provided for controlling the valve device (e.g. the control valves) for providing a second pressure (lower than the first pressure) to the second cylinder so that the piston rod engagement and disengagement device is not in engagement (i.e. disengaged or released from the piston rod) with the common piston rod.

Preferably, said features disclosed in the both previous paragraphs are combined.

Suitably, the respective piston rod engagement and disengagement device of the first and second piston device comprises at least a cavity, which being formed within the piston device. The cavity is provided for fluid communication with the respective cylinder chamber of the respective cylinder via at least a channel system.

Preferably, the channel system comprises a non-return valve or a shuttle valve or other valve that hinders the pressurized fluid in the first cylinder chamber to reach the second cylinder chamber of the cylinder and vice versa.

In such way is achieved that no fluid communication can be performed between the first and second cylinder chamber. When the first cylinder chamber is pressurized, the cavity of the piston rod engagement and disengagement device is pressurized without any effect that the pressurized fluid flows to the second cylinder chamber. The pressurization of the cavity will instantaneously expand the piston inner wall portion (flexible member), thereby directly providing a radial clamping force upon the piston rod. The cavity is positioned in the piston so that it is coaxial with and parallel with the piston inner wall portion and at a distance from the piston rod envelope surface (i.e. coaxial with the piston rod).

Suitable, the mass of material forming the piston inner wall portion exhibits a flexible material property for providing that the pressurized cavity will expand the mass of material of the inner wall portion in a radial direction (inwardly) towards the piston rod for engagement of the piston device to the piston rod.

Preferably, the channel system of the piston device comprises an inlet opening facing the cylinder chamber and an opening facing the cavity of the piston rod engagement and disengagement device, so that the cavity of piston rod engagement and disengagement device directly can be pressurized when the cylinder chamber is pressurized.

Suitably, the cavity (or cavities) extends (extend) around the longitudinal axis of the piston device and parallel and coaxially with the piston rod at a predetermined distance. The cavity (or cavities) thus extends (extend) in the direction corresponding with the cylinder axis and being formed coaxially with the X-axis of the piston device corresponding with the X-axis of the piston rod.

Preferably, when pressurizing the cavity, the radial clamping force acting on the piston rod during engagement will alter linearly with the pressurizing.

Suitably, when pressurizing, the mass of material forming the piston inner wall portion will expand uniformly towards the piston rod and provide a rigid coupling between the piston and the piston rod.

Preferably, upon depressurization, the mass of material forming the piston inner wall portion of the first piston device will revert to its original measure wherein the first piston device can slide freely along the common piston rod to be positioned to a starting position in the first cylinder ready for repeated pressurizing of the cylinder chamber and anew engaging and moving the piston rod relative the cylinder arrangement a yet further distance.

Suitably, shortly before the first cylinder is depressurized permitting the piston device to slide freely to a new position, the second cylinder is pressurized and the mass of material forming the piston inner wall portion of the second piston expands uniformly towards the piston rod and provide a rigid coupling (engagement) between the second piston device and the piston rod.

Alternatively, as soon as the second piston device is engaged with the piston rod, the first cylinder is depressurized.

Suitably, when pressurizing, the mass of material forming the piston inner wall portion and forming the membrane expands radially and engages with the piston rod in such way that the membrane is able to transfer axial forces from the piston device to the piston rod.

Preferably, each piston device (first and second or any suitable number) of a respective cylinder arrangement comprises a membrane being designed as an inner sleeve open at its ends.

The inner sleeve is preferably surrounded by an outer housing coaxially arranged around the inner sleeve and encompassing the inner sleeve.

Suitably, a cavity or a plurality of cavities being formed between an outer surface of the inner sleeve and an inner surface of the surrounding outer housing.

Alternatively, the outer housing comprises a fluid channel comprising a first opening entering the cavity and a second opening entering the outer envelope surface of the outer housing for fluid communication with the cylinder chamber via a passage provided in the piston.

Suitably, the inner sleeve is made flexible and comprises e.g. bronze-based material or other suitable materials.

Preferably, the end of the housing is covered by a support ring and the opposite end comprises a shoulder protruding inwardly for fixation of the inner sleeve to (within) the outer housing.

Alternatively, both opposite ends seen in the longitudinal direction of the housing is covered by a respective support ring for fixation of the inner sleeve to (within) the outer housing.

Preferably, seals (O-rings) are arranged in end positions of the membrane between the outer surface of the inner sleeve and the inner surface of the outer housing for providing a seal between the inner sleeve and the outer housing.

Suitably, the membrane (comprising the outer housing, inner sleeve and support ring) is mounted in the piston with a suitable bias.

Preferably, the inner surface (facing the piston rod envelope surface) of the inner sleeve is provided with a helical groove or grooves for achieving smooth operation of the piston and uniform friction between the inner sleeve and the piston rod envelope surface for effective sliding of the piston along the piston rod when the piston is disengaged from the piston rod. Such helical groove or grooves will also provide rigid engagement of the piston to the piston rod when the membrane is pressurized for engagement.

In such way is achieved a compact design and assembly of the membrane.

By means of the pressurization of the first cylinder chamber there is also achieved that the cavity automatically is pressurized for engagement of the piston device to the piston rod. This is achieved by that the pressurized fluid will enter the channel system of the piston and the passage of the outer housing and further to the cavity, thereby pressing the flexible inner sleeve in radial direction towards the piston rod for engagement. The pressurization of the cavity will instantaneously expand the inner sleeve.

By the arrangement providing the direct fluid communication between the cylinder chamber and the cavity, there is thus provided quick engagement and disengagement of the piston rod engagement and disengagement device to/from the piston rod.

There is thus provided accurate positioning of the piston to the piston rod for engagement.

There is thus achieved that eventual radial run-out is eliminated by the use of the flexible membrane.

There is in such way avoided that any running off with offset set centre of the membrane relative the piston rod will occur.

By such accurate positioning is achieved that the engagement between the piston rod and the inner surface of the piston device (membrane) will not damage the contact surfaces between the piston rod envelope surface and the piston (membrane).

Suitably, the open ends of the housing is covered by a respective support ring.

Thereby is achieved that the membrane is easy to dismount.

Preferably, the pressurized fluid is controlled to flow from the supply fluid device to respective cylinder chamber via control valves and/or logic valves.

Suitably, the pressurizing of the cavity for engagement of the piston device to the piston rod is made by direct feeding of the pressurized fluid from the cylinder chamber to the cavity.

Preferably, the pressurizing of the membrane is made via a channel system of the piston device, which channel system is provided for fluid communication between the respective cylinder chamber and the cavity of the membrane.

Suitably, the channel system has an inlet opening at the piston force area of the piston device, facing the cylinder chamber, so that the pressurized fluid is permitted to enter directly to the cavity of the membrane via the channel system.

Thereby is achieved that the pressurization of the cavity for controlling the piston rod engagement and disengagement device can be performed by controlling the control valves and/or logic valves coupled to the fluid supply.

There is thus not needed any additional fluid system or additional fluid controlled mechanical arrangement for providing an engagement of the piston device to the piston rod.

Thereby is achieved an extremely quick pressurization and/or depressurization of the cavity of the membrane.

Suitably, the piston rod engagement and disengagement device of the piston device is provided with a plurality of membranes.

Preferably, the plurality of membranes being coupled via a channel system to the respective cylinder chamber for fluid communication for pressurizing the cavities of the membranes for engaging the membrane to the piston rod.

Suitable, the cylinders are rigidly coupled to each other in axial direction forming a common cylinder arrangement along the longitudinal axis.

This is also achieved by a method for controlling a fluid actuator arrangement according to claim 16.

Preferably, the method further comprises the step of providing the second pressure to all cylinder chambers of the fluid actuator arrangement to disengage all the piston rod engagement and disengagement devices.

This is also achieved by an apparatus arranged to be infinitely movable, the apparatus includes a fluid actuator arrangement of claim 18.

This is also achieved by a data medium storing program (P) for moving an apparatus according to claim 19 and a data medium storing program product according to claim 20.

Suitably, a first and second non-return valve being arranged within the piston device and coupled to the channel system.

Preferably, the first non-return valve permits the fluid from the first cylinder chamber to enter the cavity via the common channel system and/or vice versa.

Each non-return valve will thus allow the fluid of the respective pressurized cylinder chamber to flow through the common channel to the membrane cavity providing actuating of the piston rod engagement and disengagement device without the feeding of fluid from one chamber to the other.

Suitable, at least two piston devices each comprises a channel system only provided between a first cylinder chamber and a cavity of the piston rod engagement and disengagement device for providing direct fluid communication between the cavity and the first cylinder chamber. There is in this embodiment not provided any channel between the second cylinder chamber and the cavity.

Thereby is achieved a simplified arrangement suitable to put into use in apparatuses propelled with a force just in one direction (e.g. elevators).

This is a cost effective arrangement since there is even not needed any shuttle valve.

Preferably, a return pressure is applied to a cylinder chamber for returning the piston device to a starting point. The return pressure being lower than the first pressure for not activating the piston rod engagement and disengagement device.

The foregoing and other objects and advantages of the present invention will be apparent to those skilled in the art, in view of the following detailed description, taken in conjunction with the appended claims and the accompanying drawings.

### BRIEF DESCRIPTION OF THE DRAWINGS

The present invention will now be described by way of examples with references to the accompanying schematic drawings, of which:

FIGS. 1a to 1d illustrate one aspect of the present invention;

FIGS. 2a to 2d illustrate a prior art actuator arrangement;

FIG. 3a shows a flight envelope diagram illustrating needs of performance related to Mach number;

FIG. 3b shows a graph illustrating a central pump working point relative different fluid actuator arrangements presenting different operational requirements;

FIGS. 4a to 4b illustrate an example of mounting of a prior art application versus the mounting of an arrangement according to one aspect of the invention;

FIGS. 5a to 5f illustrate the operating of a hydraulic actuator arrangement, according to one aspect of the present invention;

FIGS. 6a to 6c illustrate a lift cage and a piston rod device using the arrangement according to one aspect of the present invention;

FIGS. 7a to 7c illustrate different piston rod engagement and disengagement device according to one aspect;

FIGS. 8a to 8e illustrate a piston rod engagement and disengagement device according to several aspects of the present invention;

FIGS. 9a to 9k illustrate a method for operating an arrangement according to one aspect of the present invention;

FIGS. 10a to 10b illustrate further aspects of the present invention;

FIGS. 11a to 11f illustrate yet further aspects of the present invention;

FIGS. 12a to 12k illustrate different aspects of the present invention;

FIGS. 13a to 13d illustrate further aspects of the present invention;

FIGS. 14a and 14b illustrate apparatuses according to further aspects of the invention;

FIGS. 15a and 15b illustrate flowcharts showing alternative methods according to different aspects of the invention; and

FIG. 16 illustrates a control unit according to one aspect of the invention.

### DETAILED DESCRIPTION

Hereinafter, embodiments of the present invention will be described in detail with reference to the accompanying drawings, wherein for the sake of clarity and understanding of the invention some details of no importance may be deleted from the drawings.

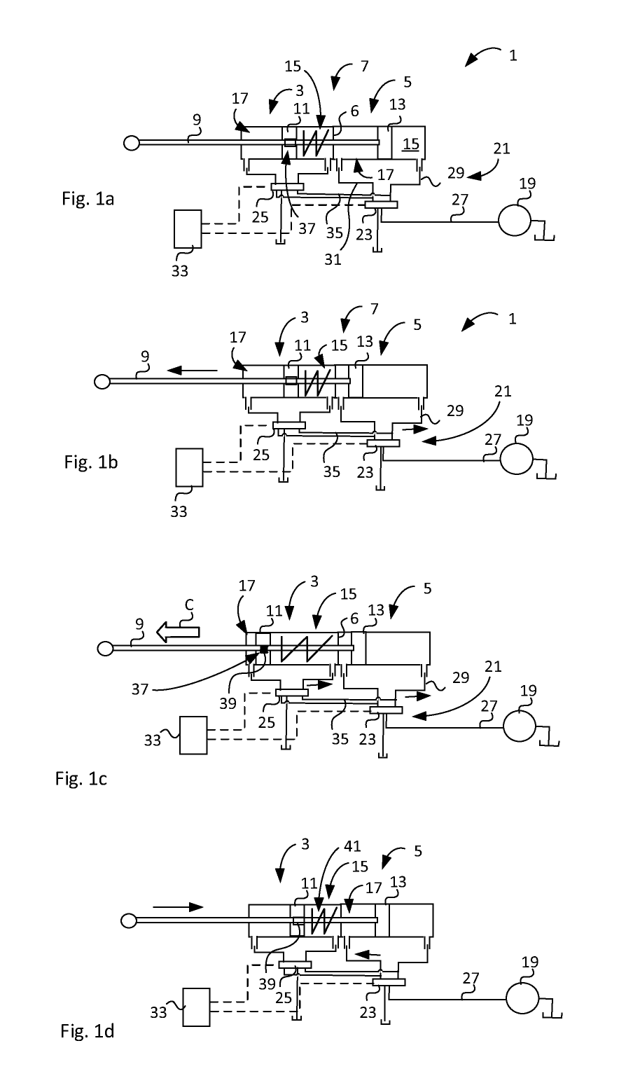

FIG. 1a schematically shows a fluid actuator arrangement 1 comprising a first 3 and second 5 cylinder of a cylinder arrangement 7. The first 3 and second 5 cylinders are arranged in tandem and rigidly fit to each other by using a common cylinder housing. A partition wall 6 is provided between the cylinders 3, 5. The arrangement 1 further comprises a common piston rod 9 and a first 11 and second 13 piston, each being coupled to the piston rod 9. The first piston 11 is arranged in the first cylinder 3 and divides the latter into a first 15 and second 17 chamber. The second piston 13 is arranged in the second cylinder 5 and divides it into a first 15 and second 17 chamber and is rigidly connected to the piston rod 9. The respective chamber 15, 17 is connected for fluid communication with a fluid pump 19 via a valve member 21 comprising a control valve 23 and a logic valve 25. The fluid pump 19 is connected to the control valve 23 by means of a fluid (hydraulic) feeding line 27. The control valve 23 is in turn connected for fluid communication with the first chamber 15 of the second cylinder 5 by means of a first fluid line 29 and also connected to the second chamber 17 of the second cylinder 5 by means of a second fluid line 31. A control unit 33 (such as a CPU) controls the control valve 23 and directs the fluid flow to the second cylinder 5 providing fast motion and low force of the piston rod 9 as is shown in FIG. 1b. In FIG. 1c is shown that the control unit 33 has made a command to the logic valve 25 to open also a third fluid line 35 provided between the first chamber 15 of the first cylinder 3 and the first fluid line 29, thereby activating the arrangement from the state shown in FIG. 1a. The first chamber 15 of the first cylinder 3 will thus also be pressurized. The first piston 11 is provided with a piston rod engagement and disengagement device 37 adapted to engage (secure) or disengage (release) the first piston 11 to/from the piston rod 9. The piston rod engagement and disengagement device 37 comprises a membrane 39 arranged adjacent a wall of an inner piston surface of said first piston 11, which membrane 39 is provided to expand and retract depending upon actual pressure fed into interior fluid guide channels (not shown) of the first piston 11. The piston rod engagement and disengagement device 37 is thus adapted to engage or disengage the first piston 11 to or from the piston rod 9 depending upon actual pressure in the respective chamber 15, 17 in the first cylinder 3. As the first chamber 15 of the first cylinder 3 being pressurized, the membrane 39 will expand and press tightly (clamp) against the piston rod 9. Such tight engagement of the first piston 11 to the piston rod 9 implies that the first piston 11 will contribute adding force (double force area) to the piston rod 9. Such contribution is shown with arrow C marking that the force now generated by the arrangement 1 is larger. In FIG. 1d is shown that the control unit 33 has shut down the feeding of fluid to the first cylinder 3 by closing the logic valve 25. As no pressure prevails in the first chamber 15 of the first cylinder 3, the membrane 39 will retract and the first piston 11 will disengage from the piston rod 9. The first piston 11 is (shortly after disengagement) positioned in symmetrical position (middle position of the second cylinder 5 seen in the longitudinal direction) be means of a spring arrangement 41. The control valve 23 is controlled to feed fluid flow to the second chamber 17 of the second cylinder 5 for pressurizing the second chamber 17 of the second cylinder 5 and returning the piston rod 9 with high motion rate and low force.

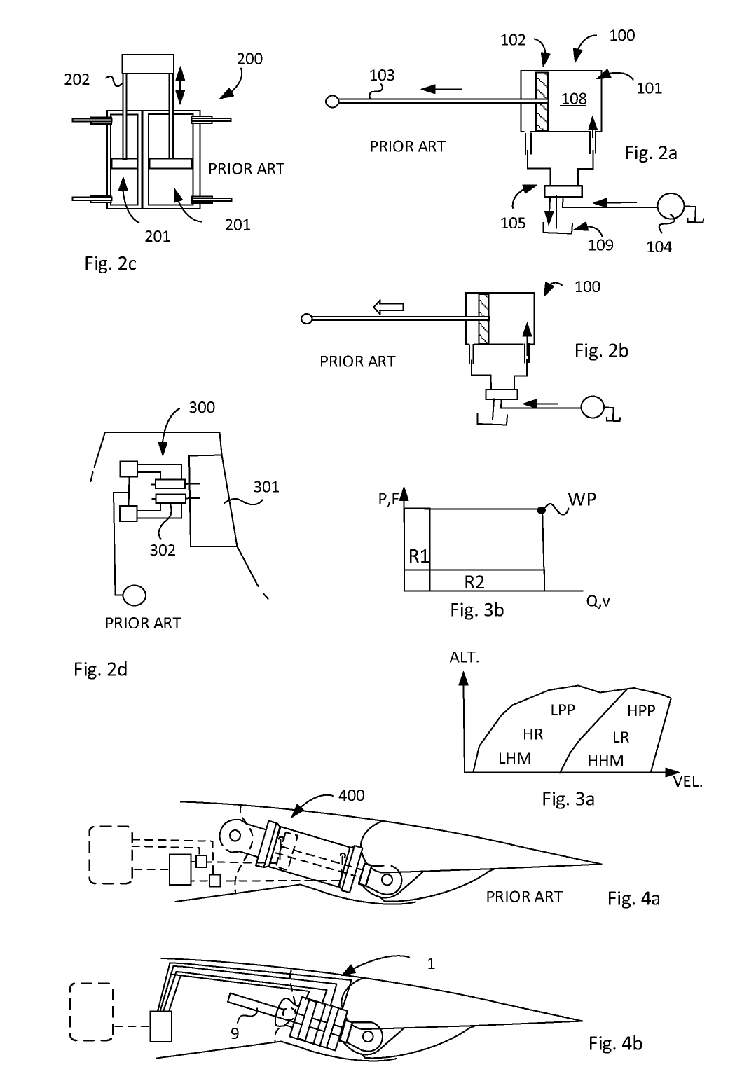

FIG. 2a shows a hydraulic actuator arrangement 100 according to prior art. The arrangement 100 comprises a cylinder 101 and a piston 102 rigidly connected to a piston rod 103. A pump 104 provides a flow of fluid to a control valve 105. The arrangement 100 is designed for highest expected motion force/load. This means that if a lower force has to be generated, a major throttling is made for decreasing the pressure in the pressurized chamber 108. This excess fluid is led to an external reservoir 109. One way to solve this is to decrease the pump action. This is however also ineffective. Especially if another prior art arrangement (not shown) is coupled to the pump 104, which prior art arrangement must perform a high force/load motion adapted to the maximal pump performance. Thereby a not efficient throttling must be performed for the hydraulic actuator arrangement 100. In FIG. 2b is shown that no throttling is performed for achieving that the arrangement 100 is maximally pressurized for motion of a high load.

FIG. 2c shows another prior art actuator arrangement 200 having two cylinders, each having a piston 201 being rigidly coupled to a common piston rod arrangement 202. In case a lower force is needed, only one cylinder is active. This arrangement is bulky for low force mode involves unnecessary motion of all pistons in the cylinders.

FIG. 2d shows a further prior art actuator arrangement 300 of a jet fighter wing. An elevator 301 is controlled by the actuator arrangement 300 having two parallel actuators 302. In case of high aircraft speed (e.g. supersonic speed) (high force is required to move the elevator 301), both actuators 302 are activated. At low speed (for example at take-off and landing) there are required a low force and high motion rate to move the elevator 301, wherein high energy losses are present.

FIG. 3a schematically shows a flight envelope diagram illustrating the performance of an actuator arrangement related to Mach number. It is herein shown that with increasing Mach number (VEL.) and decreasing altitude (ALT.), the control surface motion requirements result in that the pump pressure increases from Low Pump Pressure LPP to High Pump Pressure HPP. At the same time the required motions of an actuator arrangement are different upon actual position of the aircraft in the flight envelope. At low Mach numbers are needed High Rates HR and at high Mach numbers are needed Low Rates LR. Low Hinge Moments are marked with LHM. High Hinge Moments are marked with HHM. There is thus a need for high pump pressure and low rate actuator motion at high velocity—and low pump pressure and high rate actuator motion at low velocity—of the aircraft. According to one aspect of the present invention there is provided that rapid change of force area of the piston device can be made for achieving high force performance of the arrangement or high rate motion of the arrangement in accordance with actual operation of the aircraft.

FIG. 3b schematically illustrates a diagram (P=fluid pressure; F=force; Q=fluid flow; v=motion rate) of the working point WP of a central pump relative a set (two) of different fluid actuator arrangements (not shown) having different operational requirements regarding High Force/Low Motion Rate (Requirement R1) and High Motion Rate/Low Force (Requirement R2). For example, a first arrangement (not shown) requires High Force and Low Motion Rate and a second arrangement (not shown) requires High Motion Rate and Low Force, wherein the arrangements are connected to a common central pump proving a constant high pressure P. By means of just changing the cross-sectional force area (active piston area) of each arrangement, the Requirement R1 and Requirement R2 will be possible to full fill in an energy saving way. In such way is provided an effective, intelligent and local/distribution control of motion rate and force for each arrangement independently of each other and providing less CO2 emissions and saving energy. This aspect of the present invention also implies a total lower (relative prior art) power output of the central pump and thus lower energy losses.

FIGS. 4a to 4b illustrate an example of mounting of a prior art application versus the mounting of an arrangement 1 according to one aspect of the invention. As shown in FIG. 4a the prior art arrangement 400 is designed for only High Pump Pressure HPP, but throttled to Low Hinge Moments LHM for providing lower forces. As shown in FIG. 4b the arrangement 1 according to one aspect of the present invention is less bulky and is of lower weight. By means of the arrangement in FIG. 4b according to one aspect there is thus possible to change between high force and high velocity of the piston 9. There is a possibility to change to double force area and thus double force for a short distance by activating both cylinders in tandem. Large forces and short distance motions of being required for the piston rod in high speed and/or supersonic speed.

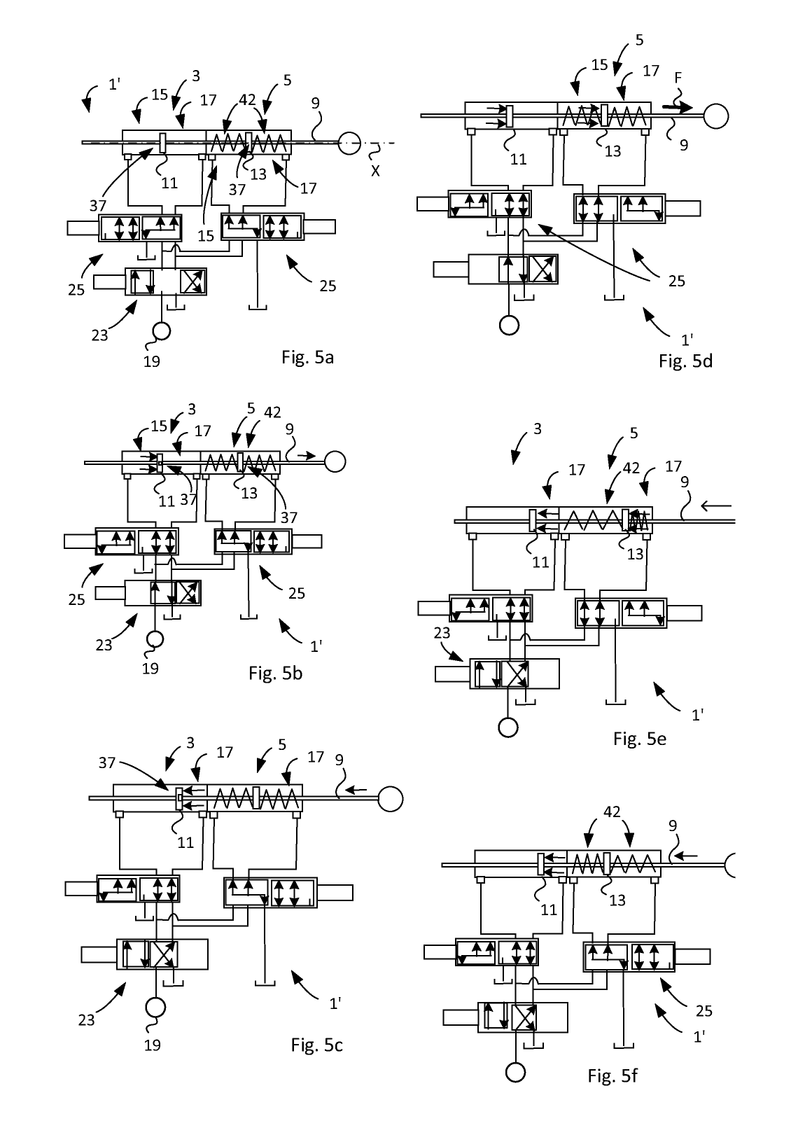

FIG. 5a to 5f schematically shows the operating of a hydraulic actuator arrangement 1′ according to one aspect of the present invention. FIG. 5a illustrates the arrangement 1′ comprising a first cylinder 3 and a second cylinder 5. A first piston 11 is arranged in the first cylinder 3 and a second piston 13 is arranged in the second cylinder 5. A spring mechanism 42 is arranged in respective cylinder 3, 5 for positioning respective piston 11, 13 symmetrically (seen in a longitudinally direction between end walls of the cylinder) in the cylinder 3, 5, when respective cylinder chamber 15, 17 is not pressurized. Only one of the spring mechanisms is shown in the FIGS. 5a to 5f for sake of clarity. A common piston rod 9 protrudes through the cylinders 3, 5 along a central longitudinal axis X. The cylinders 3, 5 are arranged in a tandem assembly and at outside ends of the assembly there is arranged a respective scraper device (not shown) for removing eventual dust and dirt from the piston rod 9 outside the cylinders 3, 5. Respective piston 11, 13 is provided with a piston rod engagement and disengagement device 37 adapted to engage (secure) or disengage (release) the pistons 11, 13 to/from the common piston rod 9. A pump 19 is connected to a control valve 23, which in turn is connected to respective chamber 15, 17 of the assembly via logic valves 25. The second cylinder 5 is connected to the control valve 23 via the right (as seen in the FIGS. 5a to 5f) positioned logic valve 25 adapted for directing the hydraulic flow to the respective chambers 15, 17 of the second cylinder 5. In FIG. 5b is shown that the first piston 11 is actuated by pressurizing the first chamber 15 of the first cylinder 3. The direction of motion is operated by controlling the control valve 23 and the activating of the respective cylinder 3, 5 is made by operating the respective logic valve 25. Such control of fluid flow to the arrangement promotes for efficient selection of working points regarding motion rate and force of the arrangement. By pressurizing the first chamber 15 of the first cylinder 3, the first piston 11 engages the common piston rod 9 by means of the piston rod engagement and disengagement device 37. The second cylinder 5 is not pressurized and no engagement is performed between the piston rod 9 and the second piston 13. The second piston 13 is not engaged with the common piston rod 9, which slides through the second piston 13 and its piston rod engagement and disengagement device 37, thus slides adjacent the piston bore inner wall of the second piston 13. Low force and high motion of the common piston rod 9 is achieved.

In FIG. 5c is shown that the control valve 23 is operated to direct the hydraulic flow from the pump 19 to the second chamber 17 of the first cylinder 3. The first piston 11 is again in engagement with the common piston rod 9 for returning the latter with a low force.

In FIG. 5d is shown that both logic valves 25 are operated to open fluid communication with the second cylinder 5 as well. The first chamber 15 of the second cylinder 5 is pressurized and the second piston 13 will engage with the common piston rod 9 in similar same way as the first piston 11. There will thus be added performance in force F acting onto the piston rod 9. Double load motion/fast accelerating heavy loads is thus achieved by the arrangement 1′ in this state.

In FIG. 5e is shown that the control valve 23 is changed for feeding hydraulic oil to re-direct the common piston rod 9 by means of engagement of the both pistons 11, 13 by pressurizing the second chamber 17 of the first cylinder 3 and the second chamber 17 of the second cylinder 5. In FIG. 5f is shown that the right logic valve 25 is closed and the second piston 13 is disengaged from the common piston rod 9, wherein the second piston 13 is returned to mid-position by means of the spring mechanism 42. The first piston 11 is engaged with the common piston rod 9 and propels the latter with minor force for accurate and fine adjustment of the common piston rod 9.

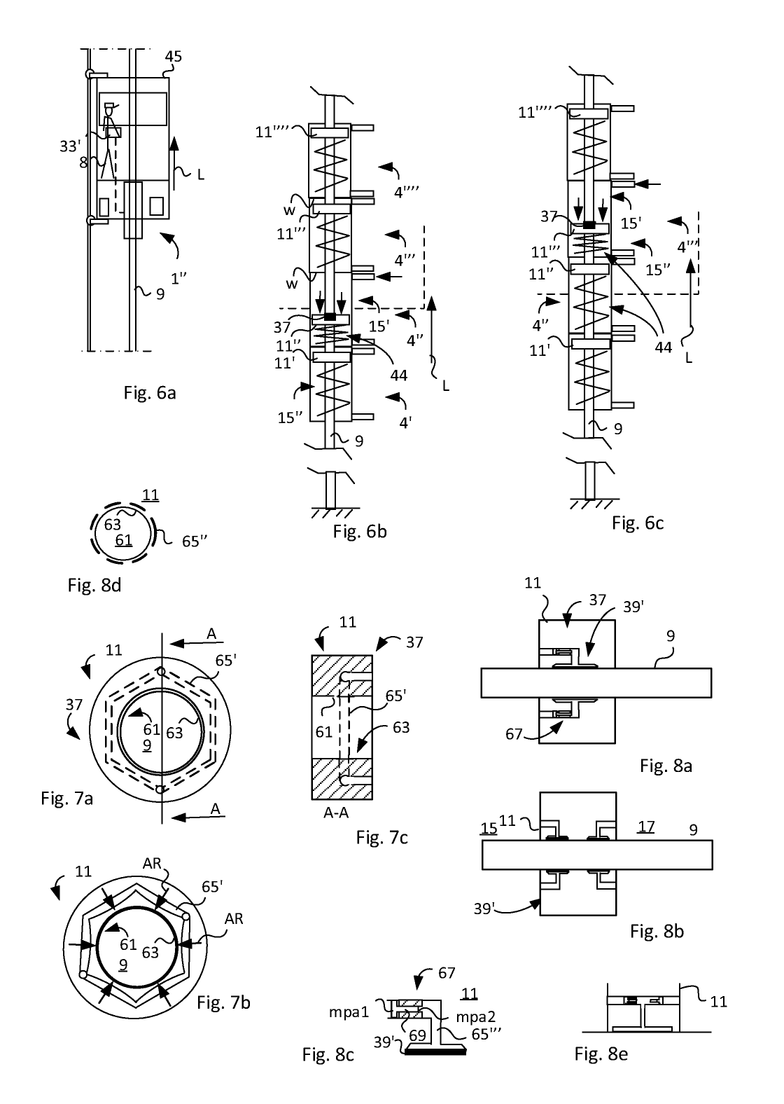

FIGS. 6a to 6c schematically illustrate a lift cage 45 and a piston rod 9 for use of an arrangement 1″ according to one aspect of the present invention. A further parallel arrangement (not shown) is also adapted to the lift cage 45. The piston rod 9 is arranged through a cylinder arrangement comprising four cylinders 4′, 4″, 4′″, 4″″ (see FIG. 6b). Respective cylinder is provided with a piston comprising a piston rod engagement and disengagement member 37 adapted for releasable engagement with the piston rod 9. As seen in FIG. 6a the arrangement 1″ is mounted in a structural portion of the lift cage 45. The operation of the arrangement 1″ is performed by a user 8 operating a control unit 33′. FIG. 6b illustrates the arrangement 1″ in closer view taken instantaneously. The arrangement 1″ comprises the first 4′, second 4″, third 4′″and fourth 4″″ cylinder with respective first 11′, second 11″, third 11′″ and fourth 11″″ piston. An upper chamber 15′ of the second cylinder 4″ is pressurized, wherein the second piston 11″ is engaged with the piston rod 9. The arrangement 1″ and lift cage 45 will thus be moved in direction L, as the upper wall w of the second cylinder 4″ is forced (pressed) in said direction. A spring 44 is arranged in each cylinder in its lower cylinder chamber 15″. The spring 44 in the second cylinder 4″ being compressed during said pressurization. Optionally, during lift start for accelerating the lift cage 45, all cylinders 4′, 4″, 4′″, 4″″ may be active, generating a large force. In FIG. 6c is shown that the third piston 11′″ is engaged with the piston rod 9 by pressurizing the upper chamber 15′ of the third cylinder 4′″. The second cylinder 4″ is not pressurized and the piston 11″ is returned to its upper position in the cylinder 4″ by said spring 44. For operating the lift cage 45 going down, the lift cage 45 is provided with a system adapted for such functionality.

FIGS. 7a to 7c schematically illustrate a piston rod engagement and disengagement device 37 according to one aspect. FIG. 7a shows a piston 11 in a front view. A bore 61 (exhibiting an inner wall section 63) is provided centrally in the piston 11 for encompassing a piston rod 9. An interior channel 65′ is arranged in the piston 11, which channel 65′ is provided with six tangent section portions. The interior channel 65′ is adapted for fluid communication with a fluid pressurized cylinder chamber (not shown) according to one aspect. Pressurized fluid is fed into the interior channel 65′ wherein the inner wall 63 expands in a radial direction inwardly according to arrows AR in FIG. 7b. In such way the piston 11 will engage the piston rod 9, when the cylinder chamber (see e.g. FIG. 6c) is pressurized for action. In FIG. 7c is illustrated a cross-section A-A taken in FIG. 7a.

FIG. 8a schematically illustrates a piston rod engagement and disengagement device 37 of a piston 11 according to one aspect. The device 37 comprises a membrane device 39′ adapted for providing releasable engagement for the piston 11 with a piston rod 9. The device 37 further comprises a pressure strengthening device 67, which is provided for strengthening the engagement of the piston 11 to the piston rod 9. The pressure strengthening device 67 is arranged within the piston 11 and is shown in an enlarged view in FIG. 8c according to one aspect. It comprises a movable micro piston rod 69 having a first micro pressure area mpa1 and a second micro pressure area mpa2. The first micro pressure area mpa1 being larger than the second micro pressure area mpa2, and is in fluid communication with the pressurized fluid of the pressurized cylinder chamber 15. The second micro pressure area mpa2 is arranged in communication with a pressure strengthening fluid provided in a cavity 65for acting upon the membrane device 39′ of the piston 11. FIG. 8b schematically illustrates one aspect of the invention, wherein a piston 11 is provided with two piston rod engagement and disengagement devices 37, each adapted for fluid communication with respective first 15 and second 17 chamber of a cylinder. FIG. 8d schematically shows a front view of a portion of a piston 11 having a central bore 61 forming an inner wall section 63. An interior circular cavity 65″ is provided in the piston 11 extending parallel with the inner wall section 63 extension. The interior circular cavity 65″ is arranged for fluid communication with corresponding cylinder chamber for pressurizing the interior circular cavity 65″, thereby expanding the inner wall section 63 for engagement functionality. FIG. 8e schematically illustrates a piston 11 comprising a common membrane using a channel system (alternatively at least one channel) adapted for a respective micro piston for alternately actuating said common membrane. The use of a common membrane involves the benefit of an optimal friction area (clamping area) of the membrane.

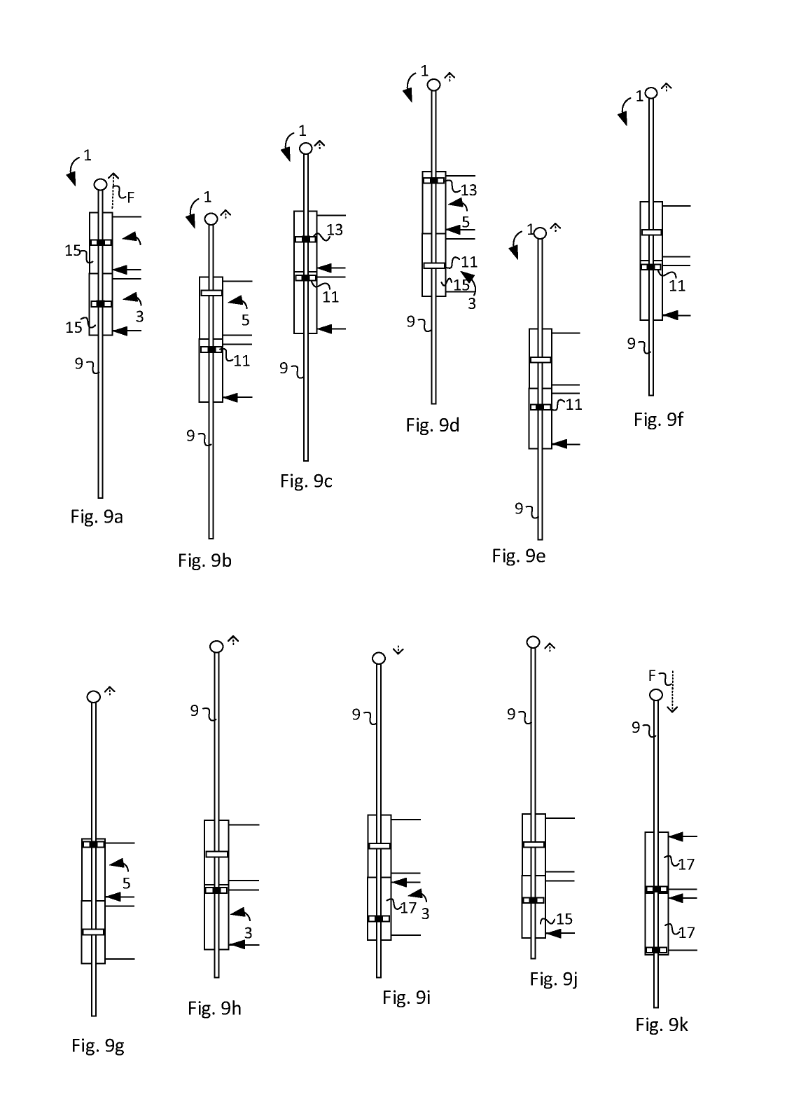

FIGS. 9a to 91 schematically illustrate a method for operating the motion of a piston rod 9 of an arrangement 1 according to one aspect of the present invention. FIG. 9a illustrates that first chamber 15 of respective cylinder (first 3 and second 5) being pressurized for accelerating a heavy load F. FIG. 9b shows that the overall force area is smaller, as the second cylinder 5 is not pressurized. However, the motion of the piston rod 9 is performed by pressurizing the first cylinder 3. FIG. 9c shows when both first 11 and second 13 pistons are in engagement with the piston rod 9. The first piston 11 is shortly held in engagement with the piston rod 9 during change of engagement to the second piston 13.

FIG. 9c thus shows a way to manage operation of the arrangement to engage the piston rod 9 and simultaneously propel the latter without faltering during switch between pistons 11 and 13.

FIG. 9d shows that the second piston 13, which is in engagement with the piston rod 9, has moved the latter, at the same time as the first piston 11 is disengaged (as the first cylinder chamber 15 not being pressurized) and has been moved to a mid-portion of the first cylinder 3 by means of a spring arrangement (not shown). Further motion of the piston rod 9 is performed in FIG. 9e, wherein the controlled pressure acts onto the piston rod 9 via the first piston 11. FIG. 9f shows further motion the first piston 11. FIG. 9g shows complementary motion by means of providing pressure to the second cylinder 5. FIG. 9h shows that yet further motion is achieved by means of the first cylinder 3. FIGS. 9i and 9j shows return of the piston rod 9 by activating the first cylinder 3 second chamber 17 and fine adjustment by activating the first chamber 15 of the first cylinder 3 to an accurate position of the piston rod 9. A major force F is generated onto the piston rod 9 as shown in FIG. 9k by pressurizing the second chambers 17 of the respective first 3 and the second 5 cylinder.

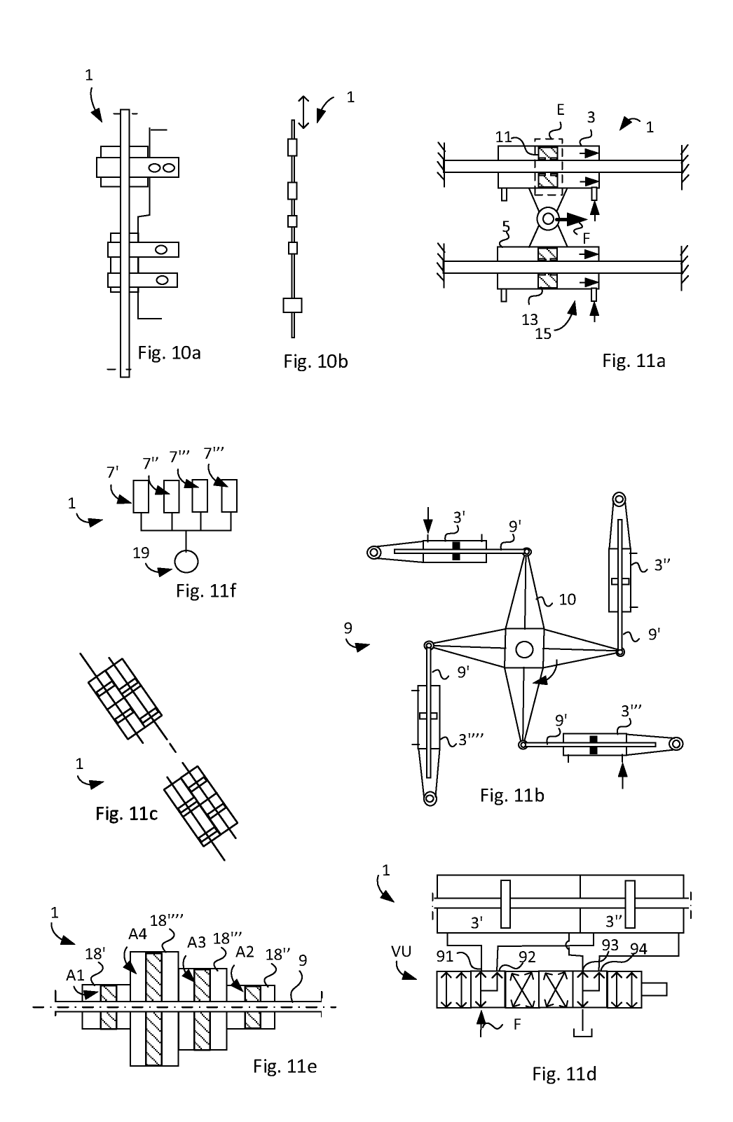

FIG. 10a schematically illustrates a further aspect of the present invention. The arrangement 1 comprises a first and a second cylinder. The first cylinder is shorter than the second cylinder.

FIG. 10b schematically illustrates a further aspect of the present invention. The arrangement 1 comprises a plurality of cylinders arranged in tandem and with a distance there between.

FIGS. 11a to 11f schematically illustrate yet further aspects of the present invention. FIG. 11a shows an arrangement 1 comprising two cylinders 3, 5 with a respective piston 11, 13. By pressurizing both first chambers 15, the pressure makes the cylinder arrangement 7 to move providing a major force F. For providing less force and higher motion rate of the cylinder arrangement 7, only one cylinder is pressurized. The respective piston being symmetrically positioned in the respective cylinder by means of an electro-magnetic device E. FIG. 11b illustrates an aspect wherein four cylinders 3′, 3″, 3′″, 3″″ are used for propelling a piston rod arrangement 9 comprising four piston rods 9′ and a four-armed-wheel 10. In FIG. 11b only two cylinders 3′, 3′″ are pressurized. FIG. 11c shows a further aspect wherein the arrangement 1 is provided for telescope functionality. FIG. 11d shows an arrangement 1 comprising an integrated logic valves unit VU. The valve unit VU transforms an electrical signal to an analogous hydraulic quantity. In the figure is shown that fluid F is fed into a first cylinder 3′ via a port 91 and at the same time into a second cylinder 3″ via a port 92. Return fluid is fed from the first cylinder 3′ via port 93 and from the second cylinder 3″ via port 94. For changing direction of motion a control valve (not shown) is operated to change fluid to be fed into ports 93 and 94. The integrated logic valves unit VU is for changing direction not operated. For changing a force/motion rate of the arrangement 1, the integrated logic valves unit VU is operated to change so that port 92 is opened for feeding fluid to the second cylinder 3″ at the same time as port 91 not being fed with fluid and the piston of the first cylinder 3′ is disengaged.

FIG. 11e shows an embodiment wherein the force area of the arrangement 1 can be changed in an optimal way. For reaching fast piston motion and minor force, a first force area A1 (e.g. 1 area unit) is activated by alternating engagement of the first 18′ and second actuator 18″ to the piston rod 9. For achievement of slow piston motion with major force, all activators 18′, 18″, 18′″, 18″″ are activated. This major force can be achieved by activating all four force areas A1, A2, A3 and A4. This means that eight area units are used, i.e. the force areas of the first, second, third, fourth actuators 18′, 18″, 18′″, 18″″ are all used together. This implies an optimal combination of eight different force area units, which can be selected from required piston motion rate and force of the piston device.

FIG. 11f shows an aspect wherein four cylinder arrangements 7′, 7″, 7′″, 7″″ of a fluid actuator arrangement 1 share one common fluid pump 19. If the first arrangement 7′ must provide high force and the second must provide high velocity, this is possible by the arrangement using the common fluid pump 9 by changing force area of the respective arrangement 7′ and 7″.

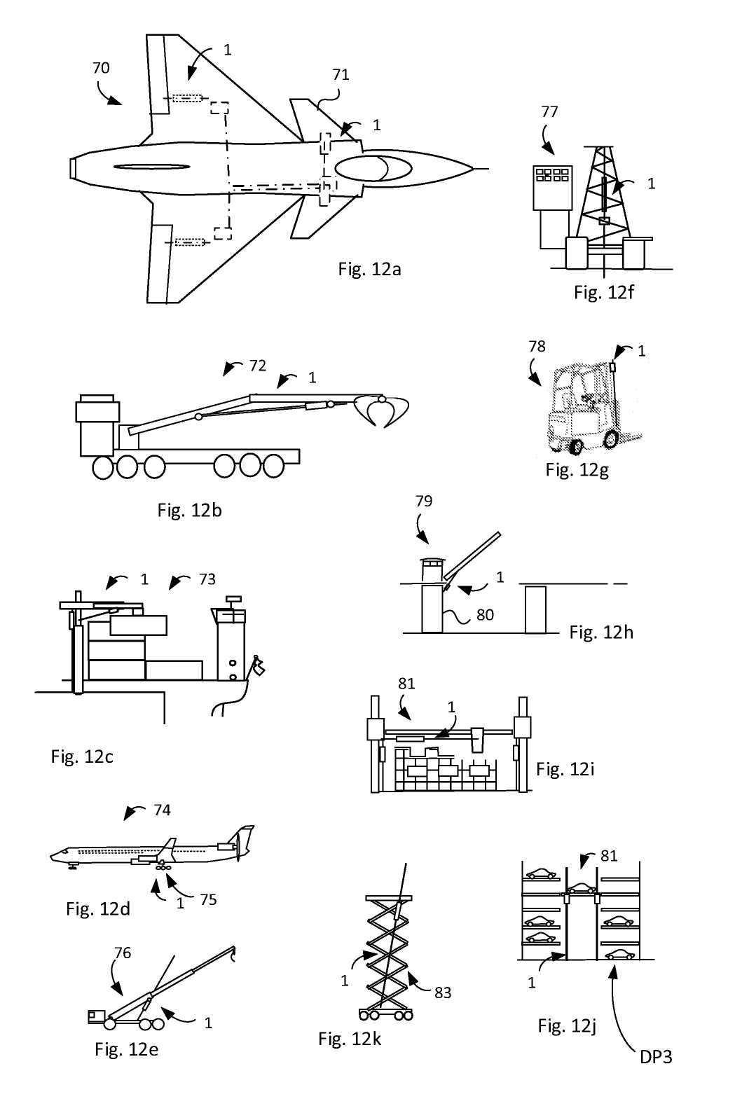

FIG. 12a schematically shows a supersonic fighter aircraft 70, which comprises the arrangement 1 according to one aspect. A canard 71 of the fighter aircraft 70 is adapted for one aspect of the arrangement 1 providing the left and right canard 71 with fast motion rate and low force in low aircraft velocity and low motion rate and high force in supersonic speed. FIG. 12b schematically illustrates a forestry machine 72 comprising a lift arm which is adapted with the arrangement 1 according to one aspect of the invention. FIG. 12c schematically shows a portion of a container terminal 73 comprising a container crane adapted to further arrangements 1 according to further aspects, offering shorter time for container ships in harbour. FIG. 12d schematically shows a commercial aircraft 74 designed for long distance flights. The landing gear retraction system 75 of the aircraft 74 is adapted for a hydraulic actuator arrangement 1 according to one aspect of the present invention. By using the arrangement, the weight of the aircraft 74 can be saved whereby improved performance is achieved, especially fuel consumption of the aircraft 74 is reduced which can be a part of “Green aviation” concept, aiming at the reduction of the operational environmental footprint of the aircraft 74. FIG. 12e schematically shows a mobile crane 76 adapted with an arrangement 1 according to yet a further aspect of the present invention. FIG. 12f schematically shows an offshore platform 77 including jacking systems used to raise and lower oil well drilling. The jacking system comprises an arrangement 1 according to one aspect. FIG. 12g schematically illustrates a forklift 78 comprising an arrangement 1 according to a further aspect. By using more compact arrangement 1, a driver will have better view which increases certainty and reduces risks. FIG. 12h schematically illustrates a bascule bridge 79 adapted with the arrangement 1 according to a further aspect. The bridge counterweight chamber 80 is adapted for encompassing the piston rod arrangement of the hydraulic actuators and thus protected from outdoor environment. FIG. 12i schematically shows a further aspect used in a 3D-printing apparatus 81 for printing of entire buildings. FIG. 12j schematically shows an automated storage and retrieval system 82 for car parking DP3, which system comprises an arrangement 1 according to a further aspect. FIG. 12k schematically shows a mobile scissor lift 83 comprising a hydraulic actuator arrangement 1 according to a further aspect.

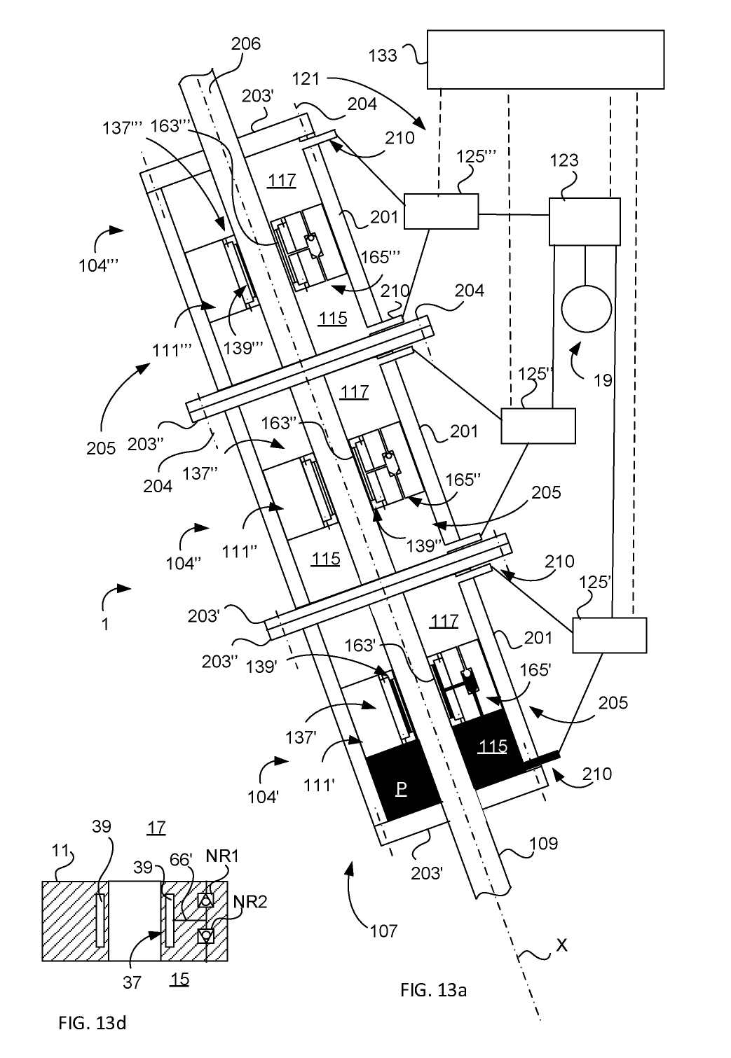

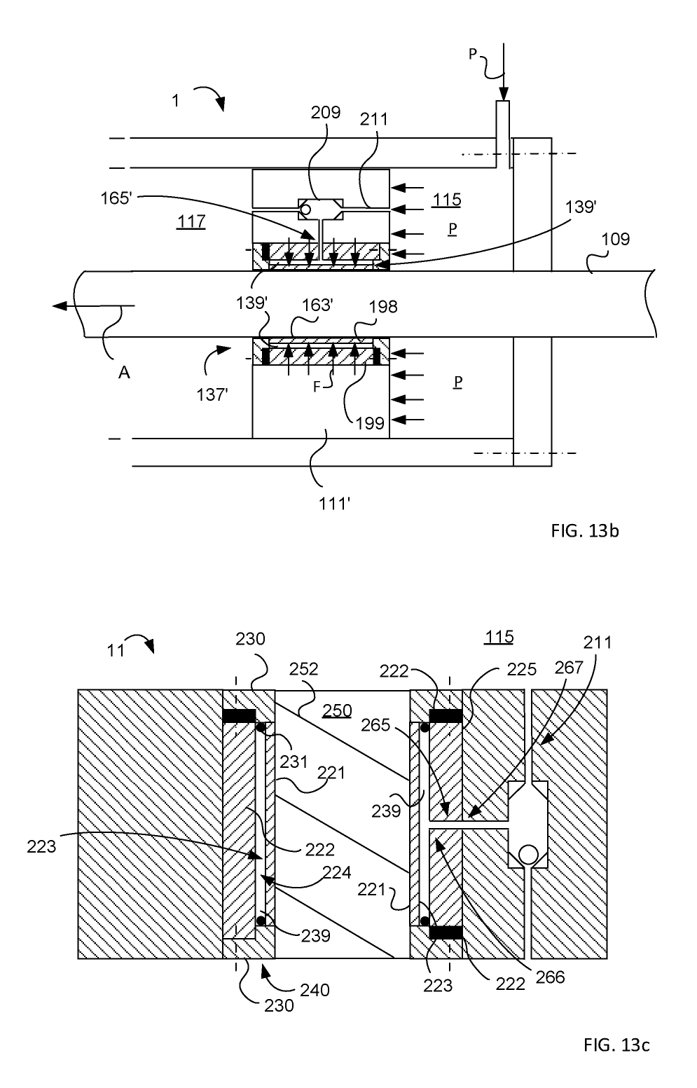

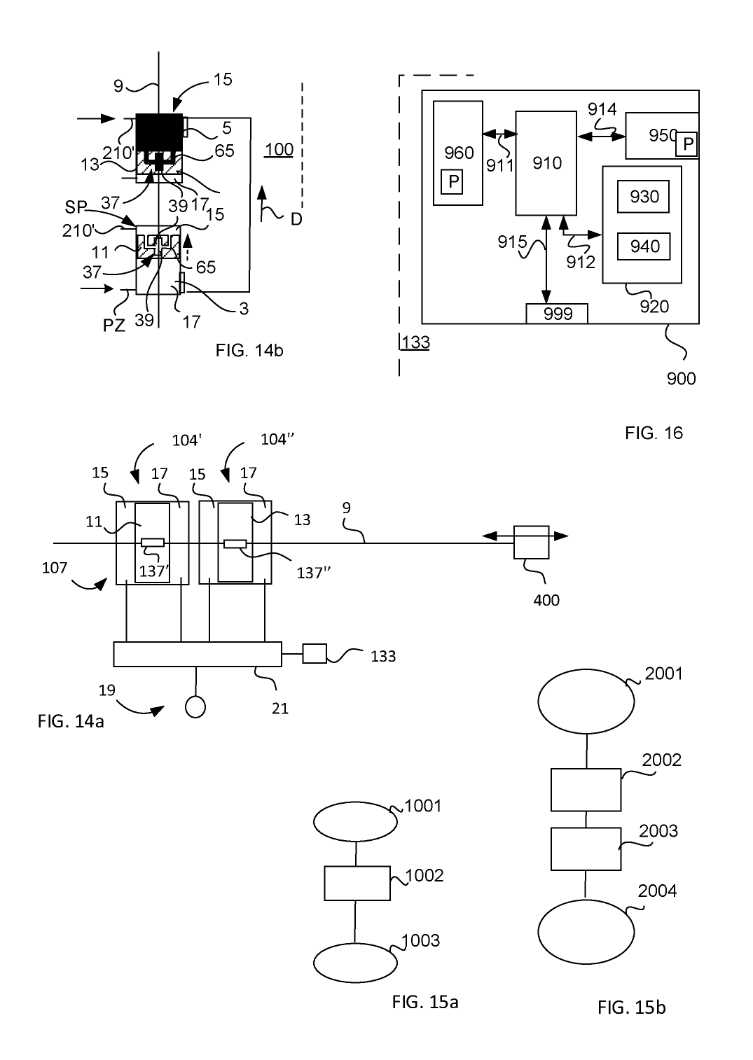

FIG. 13a shows a fluid actuator arrangement 1 comprising a first 104′, a second 104″ and a third 104″' cylinder of a cylinder arrangement 107. All cylinders 104′, 104″, 104′″ comprise a respective piston rod engagement and disengagement device 137′ (first), 137″ (second), 137′″ (third), each of which being adapted to engage or disengage a respective piston device 111′ (first), 111″ (second), 111′″ (third) of the respective cylinder 104′, 104″, 104′″ to/from a piston rod 109. Each cylinder 104′, 104″, 104′″ comprises a cylinder sleeve 201, each of which being provided with a first 203′ and second 203″ flange member. The three cylinders 104′, 104″, 104′″ are rigidly coupled to each other in axial direction along a cylinder axis X by means of bolts 204 to form the common cylinder arrangement 107.

Each cylinder 104′, 104″, 104′″ defines a cylinder space 205 in which the respective piston device 111′, 111″, 111′″ is slidingly provided. The respective piston device 111′, 111″, 111′″ is slidingly provided along the cylinder axis X and around the common piston rod 109 arranged along the cylinder axis X. The respective piston device 111′, 111″, 111′″ sealingly divides the cylinder space 205 into a first 115 and second 117 cylinder chamber. Each cylinder chamber 115, 117 comprises a fluid channel 210 provided in the cylinder sleeve 201 for permitting pressurized fluid to flow in or out to/from the respective cylinder chamber 115, 117.

The respective piston rod engagement and disengagement device 137′, 137″, 137′″ being controlled by the pressurized fluid of the actual cylinder chamber 115, 117. Alternately pressurizing of the respective cylinder chamber 115, 117 of the first cylinder 104′ with a fluid pressure P will imply that the fluid pressure P, via a first channel system 165′ of the first piston device 111′, also directly and momentary will pressurize a first cavity 139′ of the piston rod engagement and disengagement device 137′ formed in the first piston device 111′. Upon such pressurization of the cavity 139′, an expandable membrane (an inner wall portion 163′ of the first piston device 111′ will expand and press tightly (clamp) against the piston rod 109 with an inwardly directed radial force. Thus, by pressurizing the cylinder chamber 115 of the first cylinder 104′, the first piston device 111′ will directly engage the piston rod 109 by means of the piston rod engagement and disengagement device 137′ utilizing the same pressure P being applied to the first cylinder chamber 115 of the first cylinder 104′. As the first cylinder chamber 115 of the first cylinder 104′ being pressurized, the expandable membrane (first inner wall portion 163′) will expand and engage the piston device 111′ to the piston rod 109. The engagement of the first piston device 111′ to the piston rod 109 outer envelope surface 206 plus the pressurized first cylinder chamber 114, implies that the first piston device 111′ will propel the piston rod 109 a cylinder stroke length as part of an infinite and continuous motion of the piston rod.

A control unit 133 controls the valve device 121 comprising a first 125′, a second 125″ and a third 125′″ logic valve and a control valve 123 to pressurize respective cylinder chamber and at the same time the belonging piston engagement and disengagement device 137′, 137″, 137′″. In FIG. 13a is shown that the first cylinder chamber 115 of the first cylinder 104′ is pressurized and, via the first channel system 165′, simultaneously pressurize the first cavity 139′ for expanding the first flexible piston inner wall portion 163′ providing a radial clamping force onto the piston rod 109. The motion of the piston rod 109 is made by controlling the valve device 121 to pressurize the first cylinder chamber 115 of the first cylinder 104′ and, via the first channel system 165′, simultaneously pressurize the first cavity 139′ for expanding the first flexible piston inner wall portion 163′ providing a radial clamping force onto the piston rod 109. The motion of the piston rod 109 (a second distance) is made by controlling the valve device 121 to pressurize the first cylinder chamber 115 of the second cylinder 104″ and, via the second channel system 165″, simultaneously pressurize the second cavity 139″ for expanding the second flexible piston inner wall portion 163″ providing a radial clamping force onto the piston rod 109 and simultaneously (or shortly afterwards or any time there between) controlling the valve device 121 to disengage the piston rod engagement and disengagement device 137′ from the piston rod 109 by pressurizing the first cylinder chamber 115 of the first cylinder 104′ with a second pressure being lower than the first pressure so that the first flexible piston inner wall portion 163′ take its original condition (state) not engaging the piston rod 109. At the same time the second piston device 111″ (comprising the second flexible piston inner wall portion 163″) provides a radial clamping force onto the piston rod 109 and moves the piston rod 109. The steps are repeated for infinitely and continuously moving the piston rod 109.

According to one aspect the method comprises the step of providing the second pressure to all cylinder chambers 15, 17 of the fluid actuator arrangement 1 to disengage all the piston rod engagement and disengagement devices 137′, 137″, 137′″ for performing a disengagement of all piston devices 111′, 111″, 111′″, so that the arrangement 1 momentary disengage all piston devices 111′, 111″, 111′″ from the piston rod 109 in case the piston rod 109 propels a large mass using the kinetic energy of the mass (in a way reminding of a freewheel clutch).

Alternatively, a locking mode is possible, wherein a piston-like clamping device using the fluid supply system or external fluid supply systems (or wherein both chambers of respective cylinder may optionally be pressurized for activating the piston engagement and disengagement device in a locked position) is used. Such application may be advantageous in case of error in operation.

FIG. 13b shows a piston of the fluid actuator arrangement in closer detail. The piston 111′ comprises the piston rod engagement and disengagement device 137′. The first cavity 139′ is formed by an outer surface of an inner sleeve 198 and an inner surface of an outer housing 199. The inner sleeve 198 is open at its ends. The inner sleeve 198 is surrounded by the outer housing 199 and being coaxially arranged around the inner sleeve 198 and encompassing the inner sleeve 198. A cavity 139′ (or cavities) is coupled to a channel system 165′ comprising a first opening entering the cavity 139′ and a second opening entering the outer envelope surface of the outer housing 199 for fluid communication with the first cylinder chamber 115 via a passage 211 provided in the piston.

The passage 211 may have a shuttle valve 209 arranged to obstruct the fluid fed to the first cylinder chamber 115 from entering the second cylinder chamber 117. The shuttle valve 209 is tube-formed comprising three openings and a ball or other blocking valve element that moves freely within the tube (or other valve member). The shuttle valve 209 prevents the fluid from travelling from one cylinder chamber to the other, but allows the fluid to flow through a middle opening coupled to the channel system 165′. The first cylinder chamber 115 is pressurized with a pressure P for moving the piston 111′ in the direction of arrow A. The fluid fed into the first cylinder chamber 115 also enters the first channel system 165′ via the passage 211 and the shuttle valve 209 and further to the first cavity 139′. The first cavity 139′ of the piston rod engagement and disengagement device 137′ is formed by an inner side of a piston inner wall portion 163′ (i.e. outer side of the inner sleeve 198) and the inner side of the outer housing 199. The cavity (or cavities) thus extends parallel with and in a direction circumferentially around the envelope surface of the piston rod 109 and in an direction along the cylinder axis X (the cavity or cavities being e.g. cylindrical shaped and coaxially arranged within the piston rod engagement and disengagement device 137′). The mass of material forming the inner sleeve 198 adjacent the first cavity 139′ is so flexible that the increased pressure in the first cavity 139′ will expand the mass of material of the inner wall portion 163′. The piston inner wall portion 163′ is expanded by means of the pressure P and being pressed in radial direction (with a force F) towards the piston rod 109 envelope surface for engagement with the piston rod 109. By means of the pressurization of the first cylinder chamber 115 there is thus also achieved that the first cavity 139′ per se is pressurized. This is achieved by that the pressurized fluid will enter also the passage 211 of the first piston 111′ and the channel system 165′ and further to the first cavity 139′. The pressurization of the first cavity 139′ will instantaneously expand the piston inner wall portion 163′ for providing engagement between the piston device 111′ and the piston rod 109 for moving the piston rod 109.

FIG. 13c shows a piston 11 in closer detail. The piston 11 comprises a membrane 240 being designed as an inner sleeve 221 open at its ends. The inner sleeve 221 is surrounded by an outer housing 222 coaxial arranged around the inner sleeve 221 and encompassing the inner sleeve 221. A cavity 239 or a plurality of cavities being formed between an outer surface 223 of the inner sleeve 221 and an inner surface 224 of the surrounding outer housing 222. Alternatively, the outer housing 222 comprises a fluid channel 265 comprising a first end 266 entering the cavity 239 and a second end 267 entering an outer envelope surface 225 of the outer housing 222 for fluid communication with the cylinder chamber 115 via a passage 211 comprising a return valve (arranged for directing the fluid from one of the cylinder chambers to the cavity 239) provided in the piston 11. Suitably, the inner sleeve 221 is made flexible and comprises e.g. bronze-based material or other suitable materials. The open ends of the outer housing 222 is covered by a respective support ring 230 for fixation of the inner sleeve 221 to (within) the outer housing 222. Seals (O-rings) 231 are arranged in end positions of the membrane 240 between the outer surface 223 of the inner sleeve 221 and the inner surface 224 of the outer housing 222 for providing a seal between the inner sleeve 221 and the outer housing 222. Suitably, the membrane 240 (outer housing, inner sleeve and support ring) is mounted in the piston 11 with a suitable bias to the piston. Alternatively, an inner surface 250 (facing the piston rod 109 envelope surface) of the inner sleeve 221 is provided with a helical groove 252 (not shown) or grooves for achieving smooth operation of the piston 11 and uniform friction between the inner sleeve 221 and the piston rod 109 envelope surface for effective sliding of the piston 11 along the piston rod 109 when the piston 11 is disengaged from the piston rod 109. Such helical groove 252 or grooves will also provide rigid engagement of the piston 11 to the piston rod 109 when the membrane 240 is pressurized for engagement.

FIG. 13d shows a piston 11 according a further aspect. A first non-return valve NR1 prevents the fluid from travelling from a first 15 cylinder chamber to a second cylinder chamber 17. The first non-return valve NR1 permits the fluid from the second cylinder chamber 17 to enter the membrane cavity 39 via a common channel 66′. A second non-return valve NR2 prevents the fluid from travelling from the second 17 cylinder chamber to the first cylinder chamber 15. The second non-return valve NR2 permits the fluid from the first cylinder chamber 15 to enter the membrane cavity 39. Each non-return valve NR1, NR2 thus allows the fluid of the respective pressurized cylinder chamber to flow through the common channel 66′ to the membrane cavity 39 providing actuating of the piston rod engagement and disengagement device 37.

FIG. 14a illustrates an apparatus 400 arranged to be infinitely movable by means of a fluid actuator arrangement 107 comprising a first and second 104′, 104″ cylinder, a piston rod 9, a first 11 and second 13 piston device associated with the piston rod 9. The respective first 11 and second 13 piston device divides respective first and second cylinder 104′, 104″ into a first 15 and second 17 cylinder chamber provided for connection to a valve device 21 of a fluid supply device 19. The fluid actuator arrangement 107 further comprises a first and second piston rod engagement and disengagement device 137′, 137″ of the respective first 11 and second 13 piston device, a first and second cavity (not shown) of the respective piston rod engagement and disengagement device 137′, 137″ each forming a flexible piston inner wall portion (not shown), a first and second channel system (not shown) of the respective piston rod engagement and disengagement device 137′, 137″ for providing fluid communication between the respective cylinder chamber 15, 17 and the respective cavity.

FIG. 14b illustrates an arrangement (e.g. for an elevator apparatus 100) having at least two cylinders 3, 5, each of them comprising a piston 11, 13 arranged around a stationary common piston rod 9. Respective piston 11, 13 comprises a piston rod engagement and disengagement device 37. In this embodiment, there is provided a channel system 65 between a first cylinder chamber 15 and the membrane cavity 39 for direct fluid communication between the cavity 39 and the chamber 15. Since the lifting force for lifting the elevator 100 (and cylinder arrangement), in a direction D, is achieved by alternately pressurizing (with a first pressure) the respective first cylinder chamber 15 (upper chamber) and cavity 39 via fluid ports 210′, it will not be needed any channel system between the second cylinder chamber 17 and the cavity 39. There is even not needed any shuttle valve. The alternately pressurizing of the respective upper cylinder chamber 15 comprises interchange actuating of respective chamber 15 repeatedly and regularly with one another in time for lifting the elevator 100 along the stationary piston rod 9. The second chamber 17 of each cylinder 3, 5 may be pressurized via port PZ for returning of the piston to a starting point SP.

FIGS. 15a and 15b illustrate flowcharts showing methods according to different aspects of the invention. FIG. 15a illustrates a flow chart of the method according to one aspect of the invention. The method starts in a Step 1001. In Step 1002 is provided a method for controlling a fluid actuator arrangement comprising a first and second piston rod engagement and disengagement device of a respective first and second piston device. In Step 1003 the method is fulfilled and stopped. The step 1002 comprises the steps of moving a piston rod a first distance by controlling a valve device to pressurize a first cylinder chamber of the first cylinder and, via a channel system, simultaneously pressurize a first cavity for expanding a flexible piston inner wall portion providing a radial clamping force onto the piston rod; moving the piston rod a second distance, by controlling the valve device to pressurize a first cylinder chamber of a second cylinder and, via a second channel system of the second cylinder, simultaneously pressurize a second cavity for expanding a flexible piston inner wall portion providing a radial clamping force onto the piston rod and simultaneously (or shortly afterwards) controlling the valve device to disengage the piston rod engagement and disengagement device of the first cylinder from the piston rod by pressurizing the first cylinder chamber of the first cylinder with a second pressure being lower than the first pressure; and repeating the steps for moving the piston rod further distance.

FIG. 15b illustrates a flow chart of the method according to a further aspect of the invention. The method starts in a Step 2001. In Step 2002 is provided a method for controlling a fluid actuator arrangement comprising a first and second piston rod engagement and disengagement device of a respective first and second piston device corresponding to Step 1002 in FIG. 15a. The method comprises a further Step 2003 of providing the second pressure to all cylinder chambers of the fluid actuator arrangement to disengage all the piston rod engagement and disengagement devices from the common piston rod. In Step 2004 the method is fulfilled and stopped.

FIG. 16 illustrates a CPU device 900 according to one aspect of the invention. The control unit 133 of the fluid actuator arrangement 1 described in FIG. 13a may comprise the CPU device 900. The CPU device 900 comprises a non-volatile memory NVM 920 which is a computer memory that can retain stored information even when the computer is not powered. The CPU device 900 further comprises a processing unit 910 and a read/write memory 950. The NVM 920 comprises a first memory unit 930.

A computer program (which can be of any type suitable for any operational data) is stored in the first memory unit 930 for controlling the functionality of the CPU device 900.

Furthermore, the CPU device 900 comprises a bus controller (not shown), a serial communication port (not shown) providing a physical interface, through which information transfers separately in two directions. The device 900 also comprises any suitable type of I/O module (not shown) providing input/output signal transfer, an A/D converter (not shown) for converting continuously varying signals from detectors (not shown) of the production line and other monitoring units (not shown) of the production line into binary code suitable for the computer.

The CPU device 900 also comprises an input/output unit (not shown) for adaption to time and date. The CPU device 900 also comprises an event counter (not shown) for counting the number of event multiples that occur from independent events in operation. Furthermore, the CPU device 900 includes interrupt units (not shown) associated with the computer for providing a multi-tasking performance and real time computing in said production line. The NVM 920 also includes a second memory unit 940 for external controlled operation.

A data medium storing program P comprising routines adapted for controlling the control valves and provided for operating the CPU device 900 for performing the present method described herein. The data medium storing program P comprises routines for providing smooth motion of the fluid actuator arrangement in an automatic or semi-automatic way. The data medium storing program P comprises a program code stored on a medium, which is readable on the computer, for causing the control unit 200 to perform the operation of the fluid actuator arrangement by controlling the fluid actuator arrangement comprising a first and second piston rod engagement and disengagement device of a respective first and second piston device in moving a piston rod a first distance by controlling a valve device to pressurize a first cylinder chamber of the first cylinder and, via a channel system, simultaneously pressurize a first cavity for expanding a flexible piston inner wall portion providing a radial clamping force onto the piston rod; moving the piston rod a second distance, and by controlling the valve device to pressurize a first cylinder chamber of a second cylinder and, via a second channel system of the second cylinder, simultaneously pressurize a second cavity for expanding a flexible piston inner wall portion providing a radial clamping force onto the piston rod and simultaneously (or shortly afterwards) controlling the valve device to disengage the piston rod engagement and disengagement device of the first cylinder from the piston rod by pressurizing the first cylinder chamber of the first cylinder with a second pressure being lower than the first pressure; and repeating the steps for moving the piston rod further distance.

The data medium storing program P further may be stored in a separate memory 960 and/or in a read/write memory 950. The data medium storing program P is in this embodiment stored in executable or compressed data format.

It is to be understood that when the processing unit 910 is described to execute a specific function that involves that the processing unit 910 executes a certain part of the program stored in the separate memory 960 or a certain part of the program stored in the read/write memory 950.

The processing unit 910 is associated with a data port 999 for communication via a first data bus 915. The non-volatile memory NVM 920 is adapted for communication with the processing unit 910 via a second data bus 912. The separate memory 960 is adapted for communication with the processing unit 910 via a third data bus 911. The read/write memory 950 is adapted to communicate with the processing unit 910 via a fourth data bus 914. The data port 999 is preferably connectable to data links of the fluid actuator arrangement.

When data is received by the data port 999, the data will be stored temporary in the second memory unit 940. After that the received data is temporary stored, the processing unit 910 will be ready to execute the program code, according to the above-mentioned procedure. Preferably, the signals (received by the data port 999) comprise information about operational status of the fluid actuator arrangement, such as operational status regarding the position of the piston rod relative the cylinder arrangement. It could also be operational data regarding the speed and brake performance of the fluid actuator arrangement. According to one aspect, signals received by the data port 999 may contain information about actual positions of the apparatus 400 in FIG. 14 by means of a sensor means (not shown). The received signals at the data port 999 can be used by the device 900 for controlling and monitoring the operation in a cost-effective way. The signals received by the data port 999 can be used for automatically moving the piston rod between two end positions. The signals can be used for different operations of a single fluid actuator arrangement or a plurality of fluid actuator arrangements, being adapted to various industrial apparatuses, such as autonomous robot assemblies, holding devices etc. The information is preferably measured by means of suitable sensor members of the fluid actuator arrangement. The information can also be manually fed to the control unit 133 via a suitable communication device, such as a personal computer display.

Parts of the method can also be executed by the device 900 by means of the processing unit 910, which processing unit 910 runs the data medium storing program P being stored in the separate memory 960 or the read/write memory 950. When the device 900 runs the data medium storing program P, suitable method steps disclosed herein will be executed. A data medium storing program product comprising a program code stored on a medium is also provided, which product is readable on a suitable computer, for performing the method steps according to any of claims 16 to 17, when the data medium storing program P according to claim 19 is run on the control unit 133.

The arrangement may according to different aspects be adapted to one or several of following industrial segments; construction industry, jacking systems for oil well drilling and service platforms, agricultural equipment industry, marine industry, crane manufacture industry. The arrangement is not limited to be used in such segments, but also other industrial segments are possible.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims. One aspect involves that the arrangement can be adapted for momentary disengaging all pistons from the piston rod in case the piston rod propels a large mass using the kinetic energy of the mass (in a way reminding of a freewheel clutch). The valve device may comprise a logic valve of suitable type. The valve member may comprise a 5 ports/2 valve positions, so called 5/2 valve or others. The valve member may comprise a two-way valve of any type suitable for the arrangement. The manoeuvring of the valve member may be performed by means of a solenoid connected to a control unit adapted for controlling the valve member and thereby the arrangement. The arrangement may be adapted for fast and high clamp force engagement of the piston device for propelling the latter accurate also for acceleration of heavy loads. By manoeuvring the valve member, such as a logical valve, the same arrangement can perform also lower force and slow motion rate of the piston rod arrangement. A logical valve can be manoeuvred by the control unit to shut down the fluid flow to excluded cylinder/cylinders and only direct fluid flow to only one cylinder. There are different types of valves that can be used for providing the above-mentioned aspects and other aspects. Electro-hydraulic controlled valves, other types of directly controlled electro-hydraulic logical valves, etc. The arrangement can be used in civil and military, manned and unmanned aircraft: Leading/Trailing Edge Flap Actuators; Landing Gear Actuators; Air Brakes; Primary Servo Actuators (PSA); Electro-Hydrical Actuator (EHA) applications etc.

1. A fluid actuator arrangement comprising:
a first and second cylinder of a cylinder arrangement;
a piston rod arrangement;
a first and second piston device associated with the piston rod arrangement;
respective first and second piston device divides respective first and second cylinder into a first and second chamber provided for connection to a valve device of a fluid supply device;
the first piston device comprises a piston rod engagement and disengagement device, which is adapted to engage or disengage the first piston device to/from the piston rod arrangement;
the piston rod engagement and disengagement device comprises a cavity forming a flexible piston inner wall portion adapted for releasable engagement with the piston rod arrangement;
a channel system is provided for fluid communication between the respective first and second chamber and the cavity.

2. The arrangement according to claim 1, wherein the first and second cylinder being arranged in tandem and the first and second piston device being associated with a common piston rod of the piston rod arrangement.

3. The arrangement according to claim 1, wherein the second piston device comprises a piston rod engagement and disengagement device adapted to engage or disengage the second piston device to/from the piston rod arrangement.

4. The arrangement according to claim 1, wherein a third cylinder comprising a third piston device is arranged in tandem with the first and second cylinder.

5. The arrangement according to claim 1, wherein the channel system comprises a non-return valve or a shuttle valve.

6. The arrangement according to claim 1, wherein the piston rod engagement and disengagement device comprises a membrane device adapted for releasable engagement with the piston rod arrangement.

7. The arrangement according to claim 1, wherein the piston rod engagement and disengagement device comprises a pressure strengthening device, which is provided for strengthening the engagement of the first piston device to the piston rod arrangement.

8. The arrangement according to claim 1, wherein the arrangement comprises a hydraulic actuator arrangement.

9. The arrangement according to claim 1, wherein the arrangement comprises a pneumatic actuator arrangement.

10. The arrangement according to claim 1, wherein a first cross-sectional force area of the first piston device differs in measure from a second cross-sectional force area of the second piston device.

11. The arrangement according to claim 1, wherein the arrangement comprises a first actuator provided with a first force area, a second actuator provided with a force area corresponding with the first force area, a third actuator provided with a third force area, a fourth actuator provided with a fourth force area, the third force area is twice as large as the first force area, the fourth force area is twice as large as the third force area.

12. The arrangement according to claim 1, wherein the arrangement comprises a plurality of cylinders and piston devices adapted to be connectable to the piston rod arrangement.

13. The arrangement according to claim 1, wherein the arrangement comprises an electro-hydraulic cylinder apparatus.

14. An aircraft comprising an arrangement according claim 1.

15. An arrangement according to claim 1, wherein the arrangement is adapted to any of the following industrial segments; construction industry, jacking systems for oil well drilling and service platforms, agricultural equipment industry, marine industry, crane manufacture industry.

16. A method for controlling a fluid actuator arrangement comprising:
a first and second cylinder of a cylinder arrangement;
a piston rod;
a first and second piston device associated with the piston rod);
the respective first and second piston device divides respective first and second cylinder into a first and second cylinder chamber provided for connection to a valve device of a fluid supply device;
a first and second piston rod engagement and disengagement device of the respective first and second piston device;
a first and second cavity of the respective piston rod engagement and disengagement device each forming a flexible piston inner wall portion;
a first and second channel system of the respective piston rod engagement and disengagement device for providing fluid communication between the respective cylinder chamber and the respective cavity;
the method includes the steps of:
moving the piston rod a first distance by controlling the valve device to pressurize the first cylinder chamber of the first cylinder and, via the channel system, simultaneously pressurize the first cavity for expanding the flexible piston inner wall portion providing a radial clamping force onto the piston rod;
moving the piston rod second distance, by controlling the valve device to pressurize the first cylinder chamber of the second cylinder and, via the first channel system, simultaneously pressurize the first cavity for expanding the flexible piston inner wall portion providing a radial clamping force onto the piston rod and simultaneously or afterwards controlling the valve device to disengage the piston rod engagement and disengagement device of the first cylinder from the piston rod by pressurizing the first cylinder chamber of the first cylinder with a second pressure being lower than the first pressure;
repeating the steps for moving the piston rod further distance.

17. The method according to claim 16, wherein the method comprises the step of:
providing the second pressure to all cylinder chambers of the fluid actuator arrangement to disengage all the piston rod engagement and disengagement devices.

18. An apparatus arranged to be infinitely movable, the apparatus includes a fluid actuator arrangement comprising:
a first and second cylinder of a cylinder arrangement;
a piston rod;
a first and second piston device associated with the piston rod;
the respective first and second piston device divides respective first and second cylinder into a first and second cylinder chamber provided for connection to a valve device of a fluid supply device;
a first and second piston rod engagement and disengagement device of the respective first and second piston device;
a first and second cavity of the respective piston rod engagement and disengagement device each forming a flexible piston inner wall portion;
a first and second channel system of the respective piston rod engagement and disengagement device for providing fluid communication between the respective cylinder chamber and the respective cavity;
wherein the arrangement is provided for moving the apparatus an optional distance by performing the method steps according claim 16.

19. A data medium storing program for moving an apparatus according to claim 18, wherein said program comprises a program code stored on a medium, which is readable on a computer, for causing a control unit to perform the method steps of:
moving the piston rod a first distance by controlling the valve device to pressurize the first cylinder chamber of the first cylinder and, via the channel system, simultaneously pressurize the cavity for expanding the flexible piston inner wall portion providing a radial clamping force onto the piston rod;
moving the piston rod a second distance, by controlling the valve device to pressurize the first cylinder chamber of the second cylinder and, via the channel system, simultaneously pressurize the cavity for expanding the flexible piston inner wall portion providing a radial clamping force onto the piston rod and simultaneously or afterwards controlling the valve device to disengage the piston rod engagement and disengagement device of the first cylinder from the piston rod by pressurizing the first cylinder chamber of the first cylinder with a second pressure being lower than the first pressure;
repeating the steps for moving the piston rod a further distance.

20. A data medium storing program product comprising a program code stored on a medium, which is readable on a computer, for performing the method steps according to claim 16, when a data medium storing program is run on a control unit.
